(19) United States
(12) Patent Application Publication
(10) Pub. No.: US 2016/0235102 A1
(43) Pub. Date: Aug. 18, 2016

(54) SWEETENER COMPOSITION, SWEETENER PRODUCTS, AND METHODS OF SWEETENING

(71) Applicant: ALMENDRA AMERICAS, LLC, Decatur, GA (US)

(72) Inventor: KATHERINE J. OGLESBY, ATLANTA, GA (US)

(21) Appl. No.: 15/023,908

(22) PCT Filed: Sep. 17, 2014
(86) PCT No.: PCT/US14/56073

§ 371 Date: Mar. 22, 2016

Related U.S. Application Data
(60) Provisional application No. 61/881,023, filed on Sep. 23, 2013.
(60) Provisional application No. 61/974,091, filed on Apr. 2, 2014.

(51) Int. Cl. A23L 1/236; A23L 2/60; A23L 2/54

(52) U.S. Cl. CPC A23L 1/22058; A23L 1/05; A23L 2/60; A23L 2/54; A23L 1/2363; A23L 1/2366; A23V 2002/00

(57) ABSTRACT

A method of reducing oral cavity and tongue coating adherence and tongue numbing effects of a sweetener composition and imparting a more sugar-like temporal and flavor profile to a high potency sweetener, that includes providing to a person a sweetener composition that includes an encapsulated high potency sweetener or a high potency sweetener included in an emulsified mixture. The high potency sweetener is selected from the group consisting of: mogroside IV, mogroside V, Luo Han Guo sweetener, siamenoside, monatin and its salts (monatin SS, RA RS, SR). curculin, glycyrrhizic acid and its salts, thaumatin, monellin, mabinlin, brazzein, hemandulcin, phyllodulcin, glycyphyllin, phloridzin, trilobatin, baiyunoside, osladin, polypodoside A, pterocaryoside A, pterocaryoside B, mukurozioside, phlomisoside I, periandrin I, abrusoside A, cyclocarioside I, and modification or derivatives thereof.

### CROSS-REFERENCE TO RELATED APPLICATION

This application claims priority to copending U.S. Provisional application entitled “SWEETENER COMPOSITION, SWEETENER PRODUCTS, AND METHODS OF SWEETENING” having Ser. No. 61/881,023, filed on Sep. 23, 2013, which is incorporated herein by reference.

This application also claims priority to copending U.S. Provisional application entitled “SWEETENER COMPOSITION, SWEETENER PRODUCTS, AND METHODS OF SWEETENING” having Ser. No. 61/974,091, filed on Apr. 2, 2014, which is incorporated herein by reference.

### BACKGROUND

Sweet tastes of natural and synthetic high-potency sweeteners are slower in onset and longer in duration than the sweet taste produced by sugar and thus change the taste balance of a food composition. Because of these differences, use of natural and synthetic high-potency sweeteners to replace a bulk sweetener, such as sugar, in a food or beverage, causes an unbalanced temporal profile and/or flavor profile. In addition to the difference in temporal profile, high-potency sweeteners generally exhibit lower maximal response than sugar, off tastes (e.g., bitter, metallic, cooling, astringent, licorice-like taste), tongue and oral cavity numbing/tingling, and/or sweetness that diminishes on iterative tasting. Some high potency sweeteners also exhibit dramatically different sweetness intensities as a function of temperature. It is well known to those skilled in the art of food/beverage formulation that changing the sweetener in a composition requires re-balancing of the flavor and other taste components. If the taste profile of natural and synthetic high-potency sweeteners could be modified to impart specific desired taste characteristics to be more sugar-like, the type and variety of compositions that may be prepared with that sweetener would be expanded significantly. Accordingly, it would be desirable to selectively modify the taste characteristics of natural and synthetic high-potency sweeteners.

Colloids are a broad class of material systems in which a substance is microscopically dispersed throughout another substance. Some are thermodynamically stable, where the dispersions form naturally, while others require the introduction of energy to form and to be stable, meaning to resist changing properties over time. Micelles are examples of thermodynamically stable systems in which surfactants, co-surfactants and co-solvents are used to solubilize lipid type materials including lipids (i.e., fats from plant fats from plant, animal and dairy origin or fatty acids thereof) or modified lipids (i.e., hydrogenated, hydrolysed, acidified, esterified, or complexed as in lipoproteins and the like) or hydrophobic hydrocarbons (i.e., oil based flavor) or other organic liquid (i.e., an “oil”) molecules. They can be poor in industrial applications because they can be compromised by dilution, heating or by changing pH levels. Emulsions, also known as macro-emulsions, micro-emulsions, and nano-emulsions, are metastable systems with kinetic stability increasing with reduction in particle size. Emulsions are generally made out of two immiscible fluids, one being dispersed in the other, usually in the presence of surface active agents. As they are liquid/liquid systems, they do not have a static internal structure. They are obtained through the addition of energy, primarily to produce shear, leading to the fragmentation of one phase in another. They are widely used due to their ability to solubilize hydrophobic substances in an aqueous continuous phase. Stabilizers, including emulsifiers and emulsifying particles, increase the kinetic stability of the emulsion and tend to promote dispersion of the phase in which they do not dissolve very well.

Emulsions are described as having a continuous phase and a dispersed phase. An emulsion is termed an oil-in-water emulsion if the dispersed phase is an organic material and the continuous phase is water or an aqueous solution and is termed a water/-in-oil emulsion if the dispersed phase is water or an aqueous solution and the continuous phase is a lipid type material. It is also possible to have a solid continuous phase in the form of a gel network. Emulsifiers act to reduce the difference in surface tension between the phases. If done perfectly, and the difference in surface tensions closely approaches zero, very small particles can be then be stabilized through the addition of energy and the result is referred to as a nano-emulsion (See Mason T G, Wilking J N, Meleson K, Chang C B, Graves S M, “Nanoemulsions: formation, structure, and physical properties”, Journal of Physics: Condensed Matter, 2006, 18(41): R635-R666).

### SUMMARY

Embodiments of the present disclosure provide for sweetener compositions, beverages, methods of making the sweetener compositions, methods of using the sweetener compositions, and the like.

An embodiment of the present disclosure provides for a method of reducing oral cavity and tongue coating adherence and tongue numbing effects of a sweetener composition, among others, that includes: providing to a person a sweetener composition that includes a high potency sweetener, wherein the high potency sweetener is included in an emulsified mixture. In an embodiment, the high potency sweetener is selected from the group consisting of: mogroside IV, mogroside V, Luo Han Guo sweetener, siamenoside, monatin and its salts (monatin SS, RR, RS, SR), curculin, glycyrrhizic acid and its salts, thaumatin, monellin, mabinlin, brazzein, hernandulcin, phyllodulcin, glycyphyllin, phloridzin, trilobatin, baiyunoside, osladin, polypodoside A, pterocaryoside A, pterocaryoside B, mukurozioside, phlomisoside I, periandrin I, abrusoside A, cyclocarioside I, and modification or derivatives thereof.

An embodiment of the present disclosure provides for a method of imparting a more sugar-like temporal and flavor profile to a high potency sweetener, among others, that includes: providing to a person a sweetener composition that includes a high potency sweetener, wherein the high potency sweetener is included in an emulsified mixture. In an embodiment, the high potency sweetener is selected from the group consisting of: mogroside IV, mogroside V, Luo Han Guo sweetener, siamenoside, monatin and its salts (monatin SS, RR, RS, SR), curculin, glycyrrhizic acid and its salts, thaumatin, monellin, mabinlin, brazzein, hernandulcin, phyllodulcin, glycyphyllin, phloridzin, trilobatin, baivunoside, osladin, polypodoside A, pterocaryoside A, pterocaryoside B, mukurozioside, phlomisoside I, periandrin I, abrusoside A, cyclocarioside I, and modification or derivatives thereof.

An embodiment of the present disclosure provides for a method of imparting a more sugar-like temporal and flavor profile to a high potency sweetener, among others, that includes: providing to a person a sweetener composition that includes an encapsulated high potency sweetener.

Other composition, methods, features, and advantages of the present disclosure will be or become apparent to one with skill in the art upon examination of the following detailed description. It is intended that all such additional devices, systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure.

FIG. 1 illustrates a spidergraph of the beverages with gum arabic that shows greatly improved taste on all attributes except astringency.

FIG. 2A-2C illustrate spidergraphs of beverages with emulsified gum arabic that shows greatly improved taste on all attributes than their counterparts containing only gum arabic or only olive oil.

FIG. 3 illustrates a spidergraph that shows the sweet taste improvement is further is significantly enhanced by the presence of trace amines (betaine and epsilon polylysine) in the area of lingering sweetness and numbness/tingling.

FIG. 4 illustrates a spidergraph that both test beverages show greatly improved taste with respect to all taste attributes, particularly the lingering attributes of sweetness, bitterness, and numbing/tingling and also sweetness onset.

FIG. 5 illustrates a spidergraph that all beverages show greatly improved taste with respect to all taste attributes, particularly the lingering attributes of sweetness, bitterness, and numbing/tingling.

FIG. 6 is a three dimensional depiction of the rebaudioside A molecule from which the surfactant nature is apparent.

FIG. 7 illustrates a spidergraph that that illustrates the effect of aging using 0.1% oil.

FIG. 8 illustrates a spidergraph that that illustrates carbonated soft drink reduced lingering attributes.

FIG. 9 illustrates a spidergraph that that illustrates non-carbonated beverage using encapsulate Stevia.

FIG. 10 illustrates a graph of sweetness linger improvement for various embodiments.

### DETAILED DESCRIPTION

This disclosure is not limited to particular embodiments described, and as such may, of course, vary. The terminology used herein serves the purpose of describing particular embodiments only, and is not intended to be limiting, since the scope of the present disclosure will be limited only by the appended claims.

Where a range of values is provided, each intervening value, to the tenth of the unit of the lower limit unless the context clearly dictates otherwise, between the upper and lower limit of that range and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

Embodiments of the present disclosure will employ, unless otherwise indicated, techniques of in chemistry, food/beverage science, and the like, which are within the skill of the art. Such techniques are explained fully in the literature.

The following examples are put forth so as to provide those of ordinary skill in the art with a complete disclosure and description of how to perform the methods and use the compositions and compounds disclosed and claimed herein. Efforts have been made to ensure accuracy with respect to numbers (e.g., amounts, temperature, etc.), but some errors and deviations should be accounted for. Unless indicated otherwise, parts are parts by weight, temperature is in ° C., and pressure is at or near atmospheric. Standard temperature and pressure are defined as 20° C. and 1 atmosphere.

Before the embodiments of the present disclosure are described in detail, it is to be understood that, unless otherwise indicated, the present disclosure is not limited to particular materials, reagents, reaction materials, manufacturing processes, dimensions, frequency ranges, applications, or the like, as such can vary. It is also to be understood that the terminology used herein is for purposes of describing particular embodiments only, and is not intended to be limiting. It is also possible in the present disclosure that steps can be executed in different sequence, where this is logically possible. It is also possible that the embodiments of the present disclosure can be applied to additional embodiments involving measurements beyond the examples described herein, which are not intended to be limiting. It is furthermore possible that the embodiments of the present disclosure can be combined or integrated with other measurement techniques beyond the examples described herein, which are not intended to be limiting.

It should be noted that, as used in the specification and the appended claims, the singular forms “a,” “an,” and “the” include plural referents unless the context clearly dictates otherwise. Thus, for example, reference to “a support” includes a plurality of supports. In this specification and in the claims that follow, reference will be made to a number of terms that shall be defined to have the following meanings unless a contrary intention is apparent.

Prior to describing the various embodiments, the following definitions are provided and should be used unless otherwise indicated.

### DEFINITIONS

As used herein, “temporal profile” of a composition means the intensity of sweetness perceived over time in tasting of a composition by a human.

As used herein, the phrases “sugar-like characteristic”, “sugar-like taste”, “sugar-like sweet”, “sugary”, and “sugar-like” are synonymous. Sugar-like characteristics include any characteristic similar to that of sucrose and include, but are not limited to, maximal response, flavor profile, temporal profile, adaptation behavior, mouthfeel, concentration/response function behavior, tastant and flavor/sweet taste interactions, spatial pattern selectivity, and temperature effects. These characteristics are dimensions in which the taste of sucrose is different from the tastes of natural and synthetic high-potency sweeteners. Whether or not a characteristic is more sugar-like is determined by expert sensory panel assessments of sugar and compositions comprising at least one natural and/or synthetic high-potency sweetener, both with and without a sweet taste improving composition. Such assessments quantify similarities or differences of the characteristics of a composition with those comprising sugar. Suitable procedures for determining whether a composition has a more sugar-like taste are well known in the art.

As used herein, the phrase “undesirable taste” includes any taste property that is not imparted by sugars (e.g., glucose, sucrose, fructose, or similar saccharides). Non-limiting examples of undesirable tastes include soapy taste, delayed sweetness onset, lingering sweet aftertaste, carryover sweetness, recurring sweetness, lingering bitterness, metallic taste, bitter taste, cooling sensation taste or menthol-like taste, licorice-like taste, coating sensation or numb feeling of the tongue or oral cavity that subsides under significant water or food exposure, and/or the like in time. An undesirable taste can also be one that diminishes in intensity with time or temperature, when the other tastes present in a food or beverage do not.

As used herein, the phrase “natural high-potency (“NHP”) sweetener” means any sweetener found in nature which may be in raw, extracted, purified, or any other form, singularly or in combination thereof and characteristically have a sweetness potency similar to, equal to or greater than sucrose, fructose, or glucose, yet have less calories. Non-limiting examples of NHPSs include: mogroside II, mogroside III, mogroside mogroside V, mogroside VI, isomogroside V, 11-oxomogroside, siamenoside, Luo Han Guo sweetener, other Luo Han Guo extract components, monatin and its salts (monatin SS, RR, RS, SR), curculin, glycyrrhizic acid and its salts, abiziasaponin, abrusosides, in particular abrusoside A, abrusoside B, abrusoside C, abrusoside D, albiziasaponin, bayunosides, in particular bayunoside 1, bayunoside 2, brazzein, bryoside, bryonoside, bryonodulcoside, carnosifloside, carrelame, cyanin, chlorogenic acid, dihydroquercetin-3-acetate, dihydroflavenol, gaudichaudioside, gypenoside, hematoxylin, lugduname, magap, micraculin, naringin dihydrochalcone (NarDHC), pentadin, perillartine, polpodiosides, polypodoside A, scandenoside, selligueanin A, sucronate, sucrooctate, telosmoside D-tryptophane thaumatin, monellin, mabinlin, brazzein, hernandulcin, phyllodulcin, glycyphyllin, phloridzin, trilobatin, baiyunoside, osladin, polypodoside A, pterocaryoside A, pterocaryoside B, mukurozioside, phlomisoside I, periandrin I, abrusoside A, cyclocarioside I, modification or derivatives thereof rebaudioside A, rebaudioside B, rebaudioside C, rebaudioside D, rebaudioside E, rebaudioside F, rebaudioside M (sometimes referred to rebaudioside X), dulcoside A, dulcoside B, rubusoside, stevia, stevioside, other steviol glycoside extract components, and the like. In an embodiment, the stevia glycosides can be stevia derived and/or produced through fermentation techniques. NHPS also includes modified NHPSs. Modified NHPSs can include NHPSs which have been altered naturally or synthetically. For example, a modified NHPS includes NHPSs that have been fermented, contacted with enzyme, or derivatized or substituted on the NHPS. For the sake of brevity, in the description of embodiments, a modified NHPS is not expressly described as an alternative to an unmodified NHPS, but it should be understood that modified NHPSs can be substituted for NHPSs in any embodiment disclosed herein.

Purity, as used here, represents the weight percentage of a respective NHPS compound present in a NHPS extract, in raw or purified form. In one embodiment, extracts of a NHPS may be used in any purity percentage (e.g., about 25% to 100%, and any increment range described therein in increments of 0.5%). In another embodiment, when a NHPS is used as a non-extract, the purity of the NHPS can be about 25% to 100%, and any increment range described therein in increments of 0.5%. According to other embodiments, the purity of the NHPS (extract or non-extract) can be about 50% to 100%, about 70% to 100%, about 80% to 100%, about 90% to 100%; about 95% to 100%, about 95% to 99.5%, about 96% to 100%, about 97% to 100%, about 98% to 100%, or about 99% to 100%. According to particular embodiments, the purity of a stevia derived glycoside (e.g., rebaudioside A) can be about 50% to 100%, about 70% to 100%, about 80% to 100%, about 90% to 100%, about 95% to 100%, about 95% to 99.5%, about 96% to 100%, about 97% to 100%, about 98% to 100%, or about 99% to 100%. According to particularly desirable embodiments, upon crystallization of crude rebaudioside A the substantially pure rebaudioside A composition includes rebaudioside A in a purity greater than about 95% by weight up to about 100% by weight on a dry basis. In other exemplary embodiments, substantially pure rebaudioside A comprises purity levels of rebaudioside A greater than about 97% up to 100% rebaudioside A by weight on a dry basis greater than about 98% up to 100% by weight on a dry basis, or greater than about 99% up to 100% by weight on a dry basis.

As used herein, the phrase “synthetic sweetener” refers to any compositions that are not found in nature and characteristically have a sweetness potency greater than sucrose, fructose, or glucose, yet have less calories. Non-limiting examples of synthetic sweeteners suitable for embodiments of the present disclosure include advantame, sucralose, potassium acesulfame, aspartame, alitame, saccharin, cyclamate, neotame, N-[N-[3-(3-hydroxy-4-methoxyphenyl)propyl]-L-α-aspartyl]-L-phenylalanine 1-methyl ester, N-[N-[3-(3-hydroxy-4-methoxyphenyl)-3-methylbutyl]-L-α-aspartyl]-L-phenylalanine 1-methyl ester, N-[N-[3-(3-methoxy-4-hydroxyphenyl)propyl]-L-α-aspartyl]-L-phenylalanine 1-methyl ester, salts thereof, and the like.

In an embodiment, the bulking agent can include maltodextrin (10 DE, 18 DE, or 5 DE), corn syrup solids (20 or 36 DE), sucrose, fructose, glucose, arabinose, psicose, invert sugar, sorbitol, xylose, ribulose, mannose, xylitol, mannitol, galactitol, erythritol, maltitol, lactitol, isomalt, maltose, tagatose, lactose, insulin, glycerol, propylene glycol, n-acetyl glucosamine, polyols, polydextrose, cellulose and cellulose derivatives, fructooligosaccharides, and the like, and mixtures thereof.

As used herein, “colloid” includes systems containing hydrocolloids. “Hydrocolloids” include shellac and fiber; alginates, and alginic acids, an agar, a starch, a modified starch, a gelatin, carrageenan, xanthan gum, gellan gum, galactomannan, gum arabic, pectins, milk proteins and other proteins, a cellulosic, a carboxymethylcellulosic, a methylcellulosic, gum tragacanth and karaya, xyloglucan, curdlan, cereal β-glucan, soluble soybean polysaccharide, bacterial cellulose, microcrystalline cellulose, chitosan, inulin, emulsifying polymers, konjac mannan/konjac glucomannan, seed gums, and pullulan, esters of monoglycerides and fatty acids, fatty acids and their salts.

As used herein, “a lipid type material” is a lipid (i.e., fats or fatty acids) or modified lipid (i.e., hydrogenated or hydrolyzed fat, wax or sterol) or hydrophobic hydrocarbon (i.e., oil based flavor) or other organic liquid (i.e., an “oil”) (IUPAC).

As used herein, “orally ingestible composition” are synonymous and mean substances which are contacted with the mouth of man or animal, including substances which are taken into and subsequently ejected from the mouth and substances which are drunk, eaten, swallowed or otherwise ingested, and are safe for human or animal consumption when used in a generally acceptable range. These compositions include food, beverage, pharmaceutical, tobacco, nutraceutical, oral hygienic/cosmetic products, and the like.

### Discussion

Embodiments of the present disclosure provide for sweetener compositions, beverages, methods of making the sweetener compositions, methods of using the sweetener compositions, and the like.

Embodiments of the present disclosure provide for a variety of methods of reducing oral cavity and tongue coating adherence and tongue numbing effects of a sweetener composition, methods of imparting a more sugar-like temporal and flavor profile to a high potency sweetener, methods of improving perceived sweetening power through the reduction in sensory taste defects of a high potency sweetener and improved availability of the sweetener to the sweet taste receptor, methods of improving the sweetness of a sweetener, sweetener compositions, methods of making sweetener compositions, products including sweetener compositions, and the like. A variety of methods are needed to address the broad range of compositions that constitute the food, beverage, and personal care categories.

Other embodiments provide for methods of reducing or eliminating other adaptation effects including the loss of sweetness intensity on iterative tasting and the sometimes wide variability of sweetness intensity as a function of temperature.

Sensory perceptions of individual dimensions are always modulated by the balance of sensory inputs in any experience. Sensory inputs are generally categorized as the basic tastes, including sweet, sour, salty, bitter, and umami plus the aromatic dimension of flavor, electrical effects like metallic taste, and feeling factors like texture and astringency and chemesthetic pain effects including the trigeminal effects such as cooling, pungency, and numbing/prickling often associated with peppers and exposure to irritants like carbon dioxide. Sweetness is generally diminished by all other sensory inputs. Therefore, the majority of perceived sweetness enhancement for most high-potency sweeteners can be accounted for in terms of reducing sensory sweetener “detractors” including pain responses.

Sucrose exhibits a sweet taste in which the maximal response is perceived quickly and where perceived sweetness disappears relatively quickly on swallowing a food or beverage. In contrast, the sweet tastes of essentially all high-potency sweeteners reach their maximal responses somewhat more slowly and they then decline in intensity more slowly than is the case for sucrose. This decline in sweetness is often referred to as “sweetness linger” and is a major limitation for high-potency sweeteners. Slow onset of sweetness also can be a problem.

Sucrose is not known to exhibit any bitterness or mouth/tongue coating, or numbing/tingling effect; all of these attributes are considered problematic, negative sensory effects, or “taste defects”, in this discussion, particularly those of lingering or intensifying nature.

Natural high-potency sweeteners, such as stevia sweeteners, are known to have a number of taste defects and reduced sweetening power (maximum achievable sweetness intensity) relative to sugars and other high potency sweeteners, including delayed sweetness onset, bitterness, soapy taste, lingering sweetness, carryover sweetness, and recurring sweetness. In addition, stevia has a distinct sensory defect in that, in some subjects and in some instances, it leaves the tongue and overall oral cavity with a sticky, coated feeling and sometimes a numb sensation on the tongue that only subsides after significant water or other food exposure. In extreme cases, sweetness linger can last for more than 15 minutes. In extreme cases, minutes are required before the full sensation of the tongue returns. Stevia extracts which are relatively low in Reb A also have an additional soapy taste character, which is reminiscent of long straight chain carboxylic acids (i.e., octanoic acid) and/or licorice taste which is described sometimes as an aromatic character or, when contributory compounds are present at very low levels, a sensation in the back of the jaw. Steviol glycosides are currently and most commonly used as sugar reduction tools and can work acceptably in products that contain some level of sugars or sugar alcohols. However, in order for stevia sweeteners to be used to provide even more and eventually all of the sweetness in many consumer products, significant progress must be made to modify its taste profile, temporal profile and adaptive behaviors.

Other natural high potency sweeteners have additional taste defects (e.g., lingering sweetness, bitterness, metallic taste, and the like). In fact, all high potency sweeteners, including artificial compounds such as aspartame, sucralose, acesulfame potassium, saccharin, cyclamate, and the like, all have significant taste defects and adaptation phenomena such as late sweetness onset relative to sucrose, lingering sweetness, bitterness, metallic taste, and astringency. While also used as sugar reducers or replacers, they have been accepted by subsets of the population in order to remove or significantly reduce sugar in their diets.

For consumers, the most problematic taste defects of high potency sweeteners are those of lingering, mouth-coating behavior. Of critical importance for stevia sweeteners is the disturbing “pain” effect of mouth and tongue coating and tongue and oral cavity numbing/tingling that may accompany relatively high levels of the sweetener.

Although not intending to be bound by theory, it is believed that most, if not all, natural high-potency sweeteners bind nonspecifically throughout the oral cavity. Thus, they may stick to the periphery of cells, diffuse into the membranes of cells and even diffuse into cells, the majority of which are not even taste bud cells. This can explain a delay in sweetness onset since attainment of maximal receptor occupancy will occur only subsequent to diffusion of the non-caloric sweetener past an enormous concentration of non-specific binding sites and the delay in onset of maximal sweetness will be proportional to the propensity for the sweetener to engage in non-specific binding. At the same time, sweetener molecules that are released from the receptor have a very high likelihood of non-specific binding nearby the receptor only to diffuse back to the receptor and stimulate it again and again. Such a process also would delay the time required for clearance of sweetener from the sweetener receptor the time for disappearance of sweetness perception). Nonetheless, non-specific binding theory alone cannot adequately explain the extreme mouth and tongue coating and numbing/tingling sensation which are so long in duration as in the case of stevia, at least among stevia sensitive individuals. And activity limited to the sweetness receptor does not explain how this effect is so greatly enhanced by carbon dioxide.

Macro-emulsions have been used historically in the food industry to deliver flavor, provide turbidity, suspend vitamins, and colors. Micro-emulsions have been used to deliver higher loads of flavor without turbidity and to enhance creaminess in fat based food and beverage products. Despite their thermodynamic and kinetic instabilities, food emulsions, when well formulated, are known to maintain particle integrity for periods of time in excess of one year and are applied to marketplace products with ambient shelf lives of a year and more. Nano-emulsions are used increasingly as highly efficient delivery vehicles for nutrients in food systems and drugs in pharmaceutical applications (See US2011/0033525 and US2012/0329738, which are included herein by reference). They exist in nature in the simplest form as milk.

Commercially, emulsions can be delivered as liquid systems or, alternatively, their particles can be dried through a variety of techniques well known to those schooled in the art (e.g., spray drying, freeze drying, vacuum drying and evaporation) and later re-distributed into a continuous phase. Other technologies, including micro-encapsulation, may be utilized instead of, or in addition to, emulsified colloidal systems to provide the same effect as well as other effects including designed controlled release of tastes (i.e., longer lasting sweetness in chewing gum) and provide protection during processing and shelf life storage.

Hydrophobic, relatively water insoluble materials are well known to produce negative sensory effects in food, particularly bitterness and the pain sensation of oil burn. Examples include bitterness imparted by hydrophobic terpenoid flavoring materials like limonene when used at levels that exceed its solubility or when it is delivered via non-stabilized or poorly stabilized emulsions. Other examples include surfactants used at high levels which are bitter due to their saponic character, and organic acids used for food preservation, including benzoic and sorbic acids both of which display bitterness, burning and/or numbing sensations in the oral cavity, on the tongue and in the throat. Another example is the burning sensation associated with highly water insoluble materials like capsaicin. Human subjects are known to have widely varying sensitivities to these negative effects.

Understanding the structure of steviol glycosides may help in understanding the behavior of steviol glycosides as sweeteners. This discussion will focus on rebaudioside A.

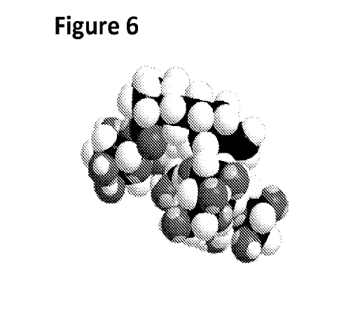

FIG. 6 is a three dimensional depiction of the rebaudioside A molecule from which the surfactant nature is apparent. (See GE Dubois, I Prakash, “Non-Caloric Sweeteners, Sweetness Modulators, and Sweetener Enhancers, Annual Review. Food Sci. Technol. 2012. 3:363.) The gray spheres represent the oxygen atoms in hydroxyl groups on the hydrophilic portion of the molecule and the black spheres represent the carbon atoms on the hydrophobic portion.

The surfactant nature of steviol glycosides has been leveraged in pharmaceutical applications. Low water solubility of bioactive compounds, resulting in their use at very high concentrations to deliver the desired pharmacological effect, is also problematic and results in negative side effects of the medicines among subjects. Surfactants can be used, in part, to increase solubility/bioavailability of bioactive compounds to the target cells and reduce the over stimulation of non-target cells incidentally exposed during a medical treatment. Sonication at high temperature and homogenization at high temperature and pressure of aqueous solutions of steviol glycoside “surfactant” and bioactive compounds are two techniques shown to further stabilize the systems to the extent that they are resistant to changes in pH, temperature and remain intact after drying and reconstitution.

Although not intending to be bound by theory, the mode of steviol glycosides action in these examples is not clearly understood but a number of modes have been proposed, including complex formation. Interesting effects of steviol glycosides have been shown, including increasing inhibition to permeability glycoprotein (p-GP) mediated influx, which should increase absorption of the insoluble or poorly soluble bioactive materials. It should be noted that a permeability glycoprotein is also referred to as multiple drug resistance protein, or MDR.

The implications of these phenomena on the taste of steviol glycosides are highly significant. The concept of complex formation on the tongue and in the oral cavity begins to make the odd, mouth coating and tongue/oral cavity numbing characteristics of steviol glycosides more easy to understand. Furthermore, p-GP mediated influx is also very important to taste receptor activity, particularly in bitter sensation. (See Ritter, S. L. & Hall, R. A. “Fine-tuning of GPCR activity by receptor-interacting proteins”, Nature Reviews, Molecular Cell Biology 10, 819-830 (2009) doi:10.1038/nrm2803.) Increasing the absorption of a material through complex formation with regard to the taste bud can certainly be a pathway for producing over-stimulation of the receptor cells. This can result in excessive contact time caused by the formation of a complex with the sensory receptor cells. The excessive contact time can be exacerbated by the inability of the aqueous solution of saliva to remove the complexed surfactant from the tongue and oral cavity. All of these factors may contribute to the negative taste characteristics of bitterness, lingering bitterness, numbing/tingling sensations and lingering numbing/tingling sensations associated with steviol glycosides. Introduction of an insoluble lipid type material, or other type of lubricant, through emulsification may alleviate the over exposure of the taste receptor by giving the steviol glycoside an insoluble material to complex instead of the taste receptor and allowing the steviol glycoside to pass to the receptor in a normal fashion with the non-polar portion of Reb A and other steviol glycosides engaged in the lipid portion of the particle. Emulsified materials clear quickly from the palate, reducing lingering and subsequent egress from any non-specifically bound material that may be residual. Furthermore, like other zwitterionic, detergent-like substances, particles are frequently capable of stabilizing positive or negative charges. This can create an alternate attraction point for the polar portion of the molecule and/or other steviol glycosides

Embodiments of the present disclosure can address not only problems associated with nonspecific binding of a high-potency sweetener by taste bud and epithelial cells and inhibiting the rate of egress of the high potency sweetener from taste bud and epithelial cells and their membranes but also the unexplained problems of mouth and tongue coating and sometimes extended numbing/tingling sensations. As a result, sweetener compositions of the present disclosure may exhibit significant reductions in sweetness, bitterness and/or numbing/tingling linger and/or significant reductions in sweetness onset, initial bitterness, and/or initial numbing/tingling and have a temporal profile more similar to a sugar temporal profiles.

In an embodiment, a sweetener composition can exhibit a more sugar-like temporal and/or sugar-like flavor profile by emulsifying a mixture including a high potency sweetener to form the sweetener composition. In an embodiment, the sweetener composition has an improved taste profile and can suppress, reduce or eliminate one or more of the undesirable taste defects of natural high-potency sweeteners and impart sugar-like characteristics to the sweetener composition. In an embodiment, the emulsified sweetener composition can be encapsulated. In an embodiment, the sweetener composition can include one or more additives (emulsified and/or encapsulated).

In an embodiment, embodiments of the present disclosure provide methods for suppressing, reducing, or eliminating, bitterness and/or numbing/tingling of a sweetener composition by emulsifying a mixture including a high potency sweetener to form the sweetener composition, and where the sweetener composition has a temporal profile more similar to a sugar temporal profile. In an embodiment, the high potency sweetener can be encapsulated and then emulsified. In an embodiment, the emulsified sweetener composition can be encapsulated. In an embodiment, the sweetener composition can include one or more additives (emulsified and/or encapsulated).

In an embodiment, embodiments of the present disclosure provide methods for suppressing, reducing, or eliminating, sweetness onset, initial bitterness, and/or initial numbing/tingling of a sweetener composition by emulsifying a mixture including a high potency sweetener to form the sweetener composition, and where the sweetener composition has a temporal profile more similar to a sugar temporal profile.

In an embodiment, embodiments of the present disclosure provide methods for suppressing, reducing, or eliminating, oral cavity and tongue coating adherence and tongue numbing effects of a sweetener composition by emulsifying a mixture including a high potency sweetener to form the sweetener composition, and where the sweetener composition has a temporal profile more similar to a sugar temporal profile.

In an embodiment, embodiments of the present disclosure provide methods for suppressing, reducing, or eliminating, the soapy taste of natural high-potency sweeteners and impart sugar-like characteristics to the sweetener composition (emulsified and/or encapsulated), and where the sweetener composition has a temporal profile more similar to a sugar temporal profile.

In an embodiment, embodiments of the present disclosure provide methods for suppressing, reducing, or eliminating, the delayed sweetness onset of natural high-potency sweeteners and impart sugar-like characteristics to the sweetener composition (e.g., with or with additives, and/or emulsified and/or encapsulated), and where the sweetener composition has a temporal profile more similar to a sugar temporal profile.

In an embodiment, embodiments of the present disclosure provide methods for suppressing, reducing, or eliminating, the lingering sweet aftertaste of natural high-potency sweeteners and impart sugar-like characteristics to the sweetener composition (e.g., with or with additives, and/or emulsified and/or encapsulated), and where the sweetener composition has a temporal profile more similar to a sugar temporal profile.

In an embodiment, embodiments of the present disclosure provide methods for suppressing, reducing, or eliminating, the carryover sweetness of natural high-potency sweeteners and impart sugar-like characteristics to the sweetener composition (e.g., with or with additives, and/or emulsified and/or encapsulated), and where the sweetener composition has a temporal profile more similar to a sugar temporal profile.

In an embodiment, embodiments of the present disclosure provide methods for suppressing, reducing, or eliminating, the recurring sweetness of natural high-potency sweeteners and impart sugar-like characteristics to the sweetener composition (e.g., with or with additives, and/or emulsified and/or encapsulated), and where the sweetener composition has a temporal profile more similar to a sugar temporal profile.

In an embodiment, embodiments of the present disclosure provide methods for suppressing, reducing, or eliminating, the lingering bitterness of natural high-potency sweeteners and impart sugar-like characteristics to the sweetener composition (e.g., with or with additives, and/or emulsified and/or encapsulated), and where the sweetener composition has a temporal profile more similar to a sugar temporal profile.

In an embodiment, embodiments of the present disclosure provide methods for suppressing, reducing, or eliminating, the metallic taste of natural high-potency sweeteners and impart sugar-like characteristics to the sweetener composition (e.g., with or with additives, and/or emulsified and/or encapsulated), and where the sweetener composition has a temporal profile more similar to a sugar temporal profile.

In an embodiment, embodiments of the present disclosure provide methods for suppressing, reducing, or eliminating, the bitter taste of natural high-potency sweeteners and impart sugar-like characteristics to the sweetener composition (e.g., with or with additives, and/or emulsified and/or encapsulated), and where the sweetener composition has a temporal profile more similar to a sugar temporal profile.

In an embodiment, embodiments of the present disclosure provide methods for suppressing, reducing, or eliminating, the cooling sensation taste or menthol-like taste of natural high-potency sweeteners and impart sugar-like characteristics to the sweetener composition (e.g., with or with additives, and/or emulsified and/or encapsulated), and where the sweetener composition has a temporal profile more similar to a sugar temporal profile.

Embodiments of the present disclosure provide methods for suppressing, reducing, or eliminating, the licorice-like taste of natural high-potency sweeteners and impart sugar-like characteristics to the sweetener composition (e.g., with or with additives, and/or emulsified and/or encapsulated), and where the sweetener composition has a temporal profile more similar to a sugar temporal profile.

In an embodiment, embodiments of the present disclosure provide methods for suppressing, reducing, or eliminating, bitterness and/or numbing/tingling of a sweetener composition using a mixture including a high potency sweetener and one or more additives as described herein to form the sweetener composition, and where the sweetener composition has a temporal profile more similar to a sugar temporal profile. In an embodiment, the high potency sweetener can be encapsulated and then emulsified. In an embodiment, the emulsified sweetener composition can be encapsulated.

In an embodiment, embodiments of the present disclosure provide methods for suppressing, reducing, or eliminating, sweetness onset, initial bitterness, and/or initial numbing/tingling of a sweetener composition using a mixture including a high potency sweetener and one or more additives as described herein to form the sweetener composition, and where the sweetener composition has a temporal profile more similar to a sugar temporal profile.

In an embodiment, embodiments of the present disclosure provide methods for suppressing, reducing, or eliminating, oral cavity and tongue coating adherence and tongue numbing effects of a sweetener composition using a mixture including a high potency sweetener and one or more additives as described herein to form the sweetener composition, and where the sweetener composition has a temporal profile more similar to a sugar temporal profile.

In an embodiment, embodiments of the present disclosure provide methods for suppressing, reducing, or eliminating, the soapy taste of natural high-potency sweeteners and impart sugar-like characteristics to the sweetener composition that includes one or more additives as described herein, and where the sweetener composition has a temporal profile more similar to a sugar temporal profile.

Colloidal suspensions (also referred to as “hydrocollodal systems”) are not generally considered taste or flavor modifiers; however, embodiments of the present disclosure can use simple to advanced stabilized colloidal compositions or systems that can be used to improve sensory performance of sweetener compositions of the present disclosure. In an embodiment, the sweetener compositions greatly reduce the oral cavity and tongue coating adherence and tongue numbing sensory defect of high potency sweeteners such as stevia, which improves the sweeteners taste, producing a more sugar-like profile with, in comparison with current art stevia containing food products, no significant delay in sweetness onset, greatly reduced bitterness and lingering sweetness and bitterness, no carryover or recurring sweetness and no soapy taste characteristics. Subsequently, they may demonstrate significantly increased perception of sweetening power relative to traditional forms of stevia. In other embodiments, a stabilized colloidal system can exhibit the ability to improve sensory performance of other high-potency sweetener compositions producing a more sugar-like profile with no significant delay in sweetness onset, greatly reduced bitterness and lingering sweetness and bitterness, no metallic or astringent taste and, subsequently, significantly increasing perceived sweetening power.

Encapsulated colloidal systems (e.g., sweetener composition including one or more encapsulated components) have been used to date to modify taste or flavor profiles; however, the purpose of the modification has been to prolong the release of the taste stimulus, not to improve the taste quality of the stimulus. Nonetheless, an encapsulated colloidal system that includes a sweetener and/or additives could, in some instances, exhibit the same taste improvement effect as a liquid dispersion.

Another advantage of stabilized colloidal systems that include a sweetener (e.g., stevia) is that, unlike non-stabilized or poorly stabilized colloidal systems, they can be combined in a food product such that they do not interact to a great extent with each other if particle size and charge issues between the systems are compatible. Therefore, the stabilized colloidal system of the sweetener composition has significantly reduced tendency to interact with flavor and other components that are delivered via other stabilized colloidal suspensions. As a result, use of the sweetener composition has little to no disruptive impact on the taste profile or the nutritional bioavailability of functional ingredients like vitamins, when it is used to replace carbohydrate sweeteners. In this regard, the stabilized colloidal system of the sweetener composition is distinct from other emulsions, such as those currently used in products. An encapsulated colloidal system that includes a sweetener would exhibit the same non-disruptive behavior to the same or greater degree.

Another advantage of stabilized colloidal systems that include a sweetener (e.g., stevia) is that, unlike non-stabilized or poorly stabilized colloidal systems, the sweetness improvement is stable with respect to changes in pH and temperature and stable on storage. This difference provides a significant commercial advantage as sweetener compositions will provide the improvement on dilution, heating or cooling, and will not be lost during the various stages of food processing and as both the sweetener composition and the sweetened composition age in the marketplace. An encapsulated colloidal system that includes a sweetener would exhibit the same type of stability to the same or greater degree.

Another method of improving the taste of natural high-potency sweeteners and high-potency sweeteners systems is through modulation of the temporal profile, which can be accomplished based on the theory of osmolality. However taste improvement can also be achieved, using one of more osmolytes whose total osmolality contribution is negligible, relative to a 10 Brix sugar solution. Similarly, additive compounds of the present disclosure that can improve sweetener (e.g., stevia) taste and produce marked improvement at levels much lower than reported. One skilled in the art would not expect either of these results based on earlier findings and reports where osmolality determines the use and amounts of components in a sweetener. However, research has shown that the cells, in a moment of osmotic stress which could be created by the binding of Reb A or other steviol glycosides to the taste receptor or any other epithelial cell, can create or maintain a desirable intracellular osmolality (Molecular Mechanisms Controlling Transmembrane Transport, E. Boles and R. Kramer, 2014, p. 156). This action could eliminate the need for highly osmotic solutions to remove the over-stimulating complexed molecule from the taste receptor and other epithelial cells, which could subsequently assist with reduction in non-specific binding and a more normal experience of the sweet taste receptor with the high potency sweetener.

In an embodiment, the sweetener composition can include one or more high potency sweeteners (e.g., natural high potency sweetener), one or more lipid type materials and one or more colloidal materials (also referred to as “hydrocollodal material”), where the mixture of these components forms a stabilized colloidal system. In an embodiment, the sweetener composition can include one or more high potency sweeteners (e.g., natural high potency sweetener), and one or more additives, where the high potency sweetener and/or can optionally be encapsulated and/or optionally included in a stabilized colloidal system (e.g., an emulsion). In an embodiment, the sweetener composition can include one or more high potency sweeteners (e.g., natural high potency sweetener), one or more lipid type materials where the mixture of these components forms a stabilized colloidal system (e.g., a nano-emulsion). In an embodiment, the sweetener composition can include one or more first additives (e.g., detergent-like additives). In an embodiment, the sweetener composition can include one or more other additives such as sugar (e.g., glucose, sucrose, and fructose), artificial sweeteners (e.g., aspartame, sucralose, saccharin, neotame, and the like), carbohydrates including psicose, polyols, salts, bitter compounds, flavorants and flavoring ingredients, astringent agents, surfactants, alcohols, and combinations thereof.

In an embodiment, the salts can be inorganic salts including halides, particularly chlorides including those formed from sodium, potassium, calcium, magnesium, zinc, iron, ammonium (NH₄⁺), pyridinium (C₅H₅NH⁺) and the like, and fluorides, nitrates and sulfates formed from the same.

In an embodiment, the salts can be organic salts including tartrates, bitartrates, lactates, carbonates, bicarbonates, acetates, citrates, including those formed from sodium, potassium, calcium, magnesium, zinc iron, and the like.

In an embodiment, the additives can include the conjugate acids of the above.

In an embodiment, the acids can be a dicarboxylic acid, tricarboxylic acid, aldonic acid, aldaric acid, alpha-hydroxy acid, or a combination thereof.

In an embodiment, the astringent agents can be carbohydrates including oatmeal. Herb sources include acacia, sage, yarrow, witch hazel, and bayberry. Solvent sources include acetic acid, isopropanol, and ethanol. Organic sources include benzoin, tannins, tannic acid, gallic acids and polyphenols of various sources and related materials. Inorganic sources include alum, potassium permanganate, zinc oxide, and zinc sulfate. Astringent agents may also include cationic and anionic polymeric materials (i.e., epsilon polylysine, polyglutamic acid, etc).

In an embodiment, the stabilized colloidal system can be a simple emulsion (e.g., particle diameter of about 0.1-5 microns), a micro-emulsion (e.g., particle diameter of 5 microns to 100 nanometers) or a nano-emulsion (e.g., particle diameter of about 1 to 100 nanometers). The stabilized colloidal system does not form aggregates such as micelles. Micelles and nano-emulsions have particles of the same approximate size; however, the amount of surfactant used is much less in a micelle than in a nano-emulsion (See US2011/0033525 and US2012/0329738 for nano-emulsions, which are included herein by reference). In an embodiment, the stabilized colloidal system can be formed by shaking, stirring, homogenizing, heating, high pressure pulverization, ultrasonic treatment or other known techniques for forming emulsions, and combinations thereof, of the mixture of the high potency sweetener, the lipid type material and the colloidal material. In addition, devices such as membrane channels microfluidic channels and membranes can be used to form the stabilized colloidal system. Heating can be combined with any of the other methods of making an emulsion to further stabilize particles and hydrate or solubilize ingredients.

In an embodiment, the high potency sweetener is included in the continuous phase of the emulsion and exposed to the processing step of the emulsion fabrication, not added post processing. When the continuous phase is aqueous, it is dissolved in the continuous phase. When the dispensed phase is aqueous, it is dissolved in the dispersed phase. In another embodiment, the high potency sweetener is dissolved in the colloidal material.

In an embodiment, the sweetener composition can include one or more high-potency sweeteners, two or more high-potency sweeteners, three of more high-potency sweeteners, and so on. In an embodiment, the high-potency sweetener can include a natural or artificial high-potency sweetener. In an embodiment, the high potency sweetener can include: mogroside IV, mogroside V, Luo Han Guo sweetener, siamenoside, other components of Luo Han Guo sweetener, monatin and its salts (monatin SS, RR, RS, SR), curculin, glycyrrhizic acid and its salts, thaumatin, monellin, mabinlin, brazzein, hernandulcin, phyllodulcin, glycyphyllin, phloridzin, trilobatin, baiyunoside, osladin, polypodoside A, pterocaryoside A, pterocaryoside B, mukurozioside, phlomisoside I, periandrin I-V, abrusoside A, abrusoside B, abrusoside C, abrusoside U, cyclocarioside I, modification or derivatives thereof, and a combination thereof. In an embodiment, the high-potency sweetener can include stevia derived glycosides such as steviosides and rebaudiosides. In an embodiment, the high-potency sweetener can include steviol monoside, steviolbioside, stevioside, rebaudioside A, rebaudioside B, rebaudioside C, rebaudioside D, rebaudioside E, rebaudioside F, rebaudioside G, rebaudioside H, rebaudioside L, rebaudioside M/X, rebaudioside N, rebaudioside O, rubusoside, dulcoside A, dulcoside B, other steviol glycoside extract components and a combination thereof. In an embodiment, the high-potency sweetener can include rebaudioside A.

Generally, the amount of high-potency sweetener in a sweetener composition varies widely depending on the particular type of sweetened composition and its desired sweetness. Those of ordinary skill in the art can readily discern the appropriate amount of high-potency sweetener put in the sweetened composition. In a particular embodiment, the high-potency sweetener can be present in the sweetened composition in an amount in the range of about 1 to 5,000 ppm of the sweetened composition.

In an embodiment, suitable amounts of high-potency sweeteners for sweetener compositions can range from: from about 50 ppm to 3,000 ppm for mogroside IV; from about 50 ppm to 3,000 ppm for mogroside V; from about 50 ppm to 3,000 ppm for Luo Han Guo sweetener; from about 5 ppm to 300 ppm for monatin, from about 5 ppm to 200 ppm for thaumatin; and from about 50 ppm to 3,000 ppm for mono-ammonium glycyrrihizin acid salt hydrate; about 1 ppm to 60 ppm for alitame; from about 10 ppm to 600 ppm for aspartame; from about 1 ppm to 20 ppm for neotame; from about 10 ppm to 500 ppm for acesulfame potassium; from about 50 ppm to 5,000 ppm for cyclamate; from about 10 ppm to 500 ppm for saccharin; from about 5 ppm to 250 ppm for sucralose; from about 1 ppm to 20 ppm for N-NN-[3-(3-hydroxy-4 methoxyphenyl)propI]-L-α-aspartyl]-L-phenylalanine 1-methyl ester; from about 1 ppm to 20 ppm for N-[N-[3-(3-hydroxy-4-methoxyphenyl)-3-methylbutyl]-L-α-aspartyl]-L-phenylalanine 1-methyl ester; and from about 1 ppm to 20 ppm for N-[N-[3-(3-methoxy-4-hydroxyphenyl) propyl]-L-α-aspartyl]-L-phenylalanine 1-methyl ester; about 30 ppm to 2,000 ppm for rebaudioside A; from about 30 ppm to 2,000 ppm for rebaudioside D; from about 30 ppm to 1,000 ppm for rebaudioside M/X; from about 50 ppm to 3,000 ppm for stevia; and from about 50 ppm to 3,000 ppm for stevioside.

In an embodiment, the lipid can be a fat from plant, animal and dairy origin. In an embodiment, the lipid can be a fatty acid derived from a fat from plant, animal and dairy origin. In an embodiment, the lipid can be a modified lipid meaning that it has been hydrogenated, hydrolysed, acidified, esterified, or complexed as in lipoproteins or the like. In an embodiment, the lipid can be a hydrophobic hydrocarbon (i.e., oil based flavor or oleoresin.

In an embodiment, the lipid can be a food-acceptable oil. In an embodiment, the oil can be a vegetable oil. In an embodiment, the oil can include a soybean oil, a coconut oil, a palm oil, a palm oil fraction, a cotton seed oil, a canola oil, an olive oil, a sunflower oil, a high oleic sunflower oil, a safflower oil, an almond or other nut oil, pulp oils, seed oils, oils from grains, rice oil, wheat germ oil and a combination thereof. In an embodiment, the oil is olive oil. In another embodiment, the oil is coconut oil. In another embodiment, the oil is high oleic sunflower oil. In another embodiment, the oil is avocado oil. In an embodiment, the oil can be present in the sweetener composition in an amount of about 1 to 15% w/w or about 1% to 25% w/w. For use in a water-in-oil emulsion, the oil can be present at 1-95% w/w.

In another embodiment, the oil can be a flavor or aromatic oil. In an embodiment, the oil can be an essential or modified essential oil of fruit, leaves, barks, stems woods rhizomes or roots. In an embodiment, the fruit essential oil can be of lemon, orange, lime, bergamot or a modified processing byproduct of any of the preceding. In an embodiment, the leaf essential oil can be of peppermint, spearmint, cornmint, eucalyptus, rosemary, sage, lavender, bay, basil or a modified processing byproduct of any of the preceding. In an embodiment, the bark essential oil can be of cinnamon, cassia, or a modified processing byproduct of any of the preceding. In an embodiment, the stems essential oil can be of citronella, geranium, clove or a modified processing byproduct of any of the preceding. In an embodiment, the wood essential oil can be turpentine or a turpentine byproduct or a modified processing byproduct of any of the preceding. In an embodiment, the root essential oil can be of ginger or a modified processing byproduct of ginger. In an embodiment, the hydrophobic hydrocarbon (i.e., terpene) or other oil is a citrus terpene or terpene alcohol, a mixture of terpenes and/or terpene alcohols or a modified processing byproduct of any of the preceding. In another embodiment, the oil can be an aroma chemical. In another embodiment, the oil is an isolate or produced by further chemical modification of the isolate. In another embodiment, the aroma chemical can be produced by chemical synthesis, including fermentation. In an embodiment, the aroma chemical can be anethole, benzyl alcohol and its esters, citronellol and its esters, geraniol/nerol and its esters, 1-menthol and its esters, or alpha terpineol and its esters. In an embodiment, the essential oil is orange or the terpene fraction of orange. In an embodiment, the essential oil is lemon or the terpene fraction of lemon. In an embodiment, the essential oil is lime or the terpene fraction of lime. In an embodiment, the aroma chemical is benzaldehyde. In an embodiment, the aroma chemical is benzyl alcohol. In an embodiment, the aroma chemical is alpha terpineol.

In another embodiment, the lipid can be a marine oil, animal fat, or mineral oil. In an embodiment, the animal fat can be milk fat.

In an embodiment, the colloidal material can include any food-grade surface active ingredient, cationic surfactant, anionic surfactant and/or amphiphilic surfactant known to those skilled in the art capable of forming an emulsion with the sweetener composition and form a stabilized colloidal system. The colloidal material can include small-molecule surfactants, fatty acids, phospholipids, proteins and polysaccharides, and derivatives thereof. In an embodiment, the colloidal material can include: lecithin, choline, phosphatidic acid, phosphatidylethanolamine, phosphatidylcholine, phosphatidylserine, phosphatidylinositol, phosphatidylinositol bisphosphate, phosphatidylinositol triphosphate, ceramide phosphorylcholine, ceramide phosphorylethanolamine, ceramide phosphoryllipid and salt forms thereof; chitosan, starches and modified starches, pectin, agar, carageenan, furcellaran, fibers, dextran, gums (e.g., locust bean gum, gum arabic, guar gum, gellan gum, gum ghatti, karaya gum, locust bean gum, tragacanth gum, xanthan gum, quillaia extract, and a combination thereof), alginic acids, alginates and derivatives thereof, cellulose and derivatives thereof, acetic acid esters of monogylcerides (ACTEM), lactic acid esters of monogylcerides (LACTEM), citric acid esters of monogylcerides (CITREM), diacetyl acid esters of monogylcerides (DATEM), succinic acid esters of monogylcerides, polyglycerol polyricinoleate, sorbitan esters of fatty acids, propylene glycol esters of fatty acids, sucrose esters of fatty acids, mono and diglycerides, fruit acid esters, stearoyl lactylates, polysorbates, starches, sodium dodecyl sulfate (SUS), stearic acid, palmitic acid, polyglycerol esters, stearoyl-2-lactylates, succinylated monoglycerides, ethoxylated monoglycerides, and a combination thereof. In an embodiment, the colloidal material can be present in the sweetener composition in an amount of about 0.1% to 15% or about 0.1% to 30%.

In an embodiment, the gum can include tree bark extracts, including shellac and edible gum. In an embodiment, the gum can include gum arabic, gum acacia, carageenans, xanthan gum, agar, guar gum, gellan gum, tragacanth gum, karaya gum, locust bean gum, lignin, fenugreek gum, alginate gum, konjac gum, ghatti gum, fucellan gum, psyllium gum, tamarind gum, gellan gum, welan gum, diutan gum, rhamsan gum, carob gum, tara gum, pullulan gum, or a combination thereof. The tree bark extract can include quillaia. In an embodiment, the gum can be gum arabic. In another embodiment, the tree bark extract can be quillaia. In an embodiment, the gum or tree bark extract can be present in the sweetener composition in an amount of about 0.1 to 30%.

In an embodiment, the sweetener composition can include one or more first additives (e.g., detergent-like additives). In an embodiment, the first additive can include an amine additive, an amino acid additive, a polyamino acid additive, a sulfonate additive, a phosphate additive, a fluoric acid, a sulfuric acid, a sugar acid additive, a nucleotide additive, a salt thereof, and a combination thereof. In an embodiment, the detergent-like materials can include alkyl sulfonates, alkyl phosphates, alkyl sulfates, O-alkyl sugars, and the like. In an embodiment, the acid additives can be in the D- or L-configuration. In an embodiment, two or more additives can be used in the sweetener composition, three or more additives can be used in the sweetener composition, four or more additives can be used in the sweetener composition, and the like. The amount of each additive can be adjusted or balanced to optimize the imparted sweetness and reducing or eliminating taste effects. In an embodiment including one or more first additives, the sweetener composition can optionally be emulsified and/or one or more components of the sweetener composition can be encapsulated.

In an embodiment, the amine additive can include primary, secondary or tertiary amines, such as alkyl amine, alkyl diamines, alkyl triamines, or other substituted amines. In an embodiment, the amine additive can be present in the sweetener composition in an amount of about 1 to 2500 or about 1 to 5000 ppm.

In an embodiment, the amino acid additives can include aspartic acid, arginine, glycine, glutamic acid, gluconic acid, proline, threonine, theanine, cysteine, cystine, alanine, valine, tyrosine, leucine, isoleucine, asparagine, serine, lysine, histidine, ornithine, methionine, camitine, aminobutyric acid (alpha-, beta-, or gamma-isomers), glutamine, hydroxyproline, taurine, norvaline, sarcosine, and their salt forms such as sodium or potassium salts or acid salts. In an embodiment, the amino acid additives can be in the D- or L-configuration and in the mono-, di-, or tri-form of the same or different amino acids and the amino acid additive can be the α-, β-, γ-, σ-, and ε-isomers, if appropriate. The amino acids may be natural or synthetic. The amino acids also may be modified. Modified amino acids refers to any amino acid wherein at least one atom has been added, removed, substituted, or combinations thereof (e.g., N-alkyl amino acid, N-acyl amino acid, or N-methyl amino acid). For examples the modified amino acids can include amino acid derivatives such as trimethyl glycine, N-methyl-glycine, and N-methyl-alanine. As used herein, modified amino acid also may encompass peptides and polypeptides (e.g., dipeptides, tripeptides, tetrapeptides, and pentapeptides) such as glutathione and L-alany 1-Lglutamine. In an embodiment, the amino acid additive can be present in the sweetener composition in an amount of about 50 ppm to 12,000 ppm or about 50 ppm to 25,000 ppm.

In an embodiment, the polyamino acid additives can include poly-L-aspartic acid, poly-L-lysine (e.g., poly-L-α-lysine or poly-L-ε-lysine), poly-L-ornithine (e.g., poly-L-α-ornithine or poly-L-ε-omithine), poly-L-arginine, poly glutamic acid, gamma poly glutamic acid, other polymeric forms of amino acids, and salt forms thereof (e.g., magnesium, calcium, potassium or sodium salts such as L-glutamic acid mono sodium salt). The sweet taste improving polyamino acid additives also may be in the D- or L-configuration and have the polyamino acids may be α-, β-, γ-, σ-, and ε-isomers, if appropriate. Combinations of the foregoing polyamino acids and their corresponding salts (e.g., sodium, potassium, calcium, magnesium salts or other alkali or alkaline earth metal salts thereof or acid salts) also are suitable polyamino acid additives. The polyamino acids may be natural or synthetic. The polyamino acids also may be modified, such that at least one atom has been added, removed, substituted, or combinations thereof (e.g., N-alkyl polyamino acid or N-acyl polyamino acid). As used herein, polyamino acids encompass both modified and unmodified polyamino acids. In an embodiment, the polyamino acid additive can be present in the sweetener composition in an amount of about 15 ppm to 1,000 ppm or about 15 ppm to 2,000 ppm.

In an embodiment, the sulfonate additive can include docusate (e.g., dioctyl sodium sulfosuccinate), fluorosurfactants that are sulfonated, alkyl benzene sulfonates, and the like. In an embodiment, the sulfonate additive can be present in the sweetener composition in an amount of about 0.1 ppm to 8 ppm or about 0.1 ppm to 15 ppm.

In an embodiment, the phosphate additive can include an alkyl aryl ether phosphate, alkyl ether phosphates, or the like. In an embodiment, the phosphate additive can be present in the sweetener composition in an amount of about 0.5 ppm to 1000 ppm or about 0.5 ppm to 2000 ppm.

In addition to sulfuric acid, other inorganic acid additives can be included in the sweetener composition. In an embodiment, the inorganic acid additives can include, but are not limited to, phosphoric acid, phosphorous acid, polyphosphoric acid, hydrochloric acid, sulfuric acid, carbonic acid, sodium dihydrogen phosphate, and their corresponding alkali or alkaline earth metal salts thereof (e.g., inositol hexaphosphate Mg/Ca). In an embodiment, the sulfuric acid or other inorganic acid additives can be present in the sweetener composition in an amount of about 5 ppm to 2,500 ppm or about 5 ppm to 5,000 ppm.

In an embodiment, the sugar acid additives can include aldonic uronic, aldaric, gluconic, glucuronic, glucaric, galactaric, galacturonic, alpha hydroxyl acid, and their salts (e.g., sodium, potassium, calcium, magnesium salts or other physiologically acceptable salts), and combinations thereof. In an embodiment, the sugar acid additives can be present in the sweetener composition in an amount of about 5 ppm to 2,500 ppm or about 5 ppm to 5,000 ppm.

In an embodiment, the dicarboxylic acid and tricarboxylic acid additives can include oxalic, malonic, succinic, glutaric, tartaric, adipic, pimelic, suveric azelaic, sebacic undecanedioic, dodecanedioic, phtalic, isophtalic, terephthalic, diphenic, maleic, fumaric, glutaconic, traumatic, muconic, citric, isocitric, aconitic, trimesic, and a combination thereof.

In an embodiment, the nucleotide additives can include inosine monophosphate (“IMP”), guanosine monophosphate (“GMP”), adenosine monophosphate (“AMP”), cytosine monophosphate (CMP), uracil monophosphate (UMP), inosine diphosphate, guanosine diphosphate, adenosine diphosphate, cytosine diphosphate, uracil diphosphate, inosine triphosphate, guanosine triphosphate, adenosine triphosphate, cytosine triphosphate, uracil triphosphate, and their alkali or alkaline earth metal salts, and combinations thereof. In an embodiment, the nucleotide additive can include nucleosides or nucleic acid bases (e.g., guanine, cytosine, adenine, thymine, and uracil). In an embodiment, the sugar acid additives can be present in the sweetener composition in an amount of about 2.5 ppm to 500 ppm or about 2.5 ppm to 1,000 ppm.

In addition, the sweetener composition can include additives such as citric acid, betaine (trimethylglycine), and epsilon polylysine. In an embodiment, the amount of citric acid in the sweetener composition can be about 0.001 to 10% w/w. In an embodiment, the amount of betaine in the sweetener composition can be about 0.0005 to 90% w/w or about 0.19% w/w. In an embodiment, the amount of epsilon polysine in the sweetener composition can be about 0.002 to 0.1% w/w or about 0.03% w/w.

In addition, the sweetener composition can include additives such as citric acid, glycine, betaine (trimethylglycine), and epsilon polylysine. In an embodiment, the amount of citric acid in the sweetener composition can be about 0 to 10% w/w. In an embodiment, the amount of glycine in the sweetener composition can be about 20 to 90% w/w or about 010% w/w. In an embodiment, the amount of betaine in the sweetener composition can be about 0.0005 to 20% w/w or about 0.19% w/w. In an embodiment, the amount of epsilon polysine in the sweetener composition can be about 0.002 to 0.1% w/w or about 0.03% w/w.

In an embodiment, the sweetener composition can include alpha hydroxy acid.

In an embodiment, the sweetener composition can include bitter compound additives for use in embodiments of the present disclosure include, but are not limited to, caffeine, theobromine, quinine, urea, bitter orange oil, naringin, quassia, and salts thereof.

In an embodiment, the sweetener composition can contain one or more flavorant and flavoring ingredient additives. “Flavorant” and “flavoring ingredient” are synonymous, and include natural or synthetic substances or combinations thereof. In an embodiment, the flavorants also include any other substance that imparts flavor, and may include natural or non-natural (synthetic) substances which are safe for human or animals when used in a generally accepted range.

In an embodiment, the sweetener composition includes flavonoid additives such as flavonols, flavones, flavanones, flavan-3-ols, isoflavones, or anthocyanidins. Non-limiting examples of flavonoid additives include catechins, polyphenols, rutins, neohesperidin, naringin, neohesperidin dihydrochalcone, and the like.

In an embodiment, the polyphenol is from grapeseed extract. In another embodiment, the polyphenol is from tea. In another embodiment, the polyphenol is from green or roasted coffee extract.

In an embodiment, the sweetener composition can include other additives as needed to provide the desired taste, texture, smell, appearance and the like.

In an embodiment, the sweetener composition can be made by forming an emulsion that includes one or more high-potency sweetener. In particular, a mixture including the high-potency sweetener can also include a lipid type material and a colloidal material, as described herein. As mentioned above, the mixture forms a stabilized colloidal system that can be formed by heating and/or shaking, stirring, homogenizing, high pressure pulverization or other known techniques for forming emulsions, and combinations thereof, of the mixture of the high potency sweetener, the lipid type material and the colloidal material. In addition, devices such as membrane channels microfluidic channels and membranes may be used.

In addition, the sweetener composition can include additives such as citric acid, gum arabic, olive oil, betaine (trimethylglycine), and salt (sodium or potassium chloride). In an embodiment, the amount of citric acid in the sweetener composition can be about 0.001 to 10% w/w. In an embodiment, the amount of gum arabic in the sweetener composition can be about 5 to 50% w/w. In an embodiment, the amount of olive oil in the sweetener composition can be about 0.005 to 10% w/w. In an embodiment, the amount of betaine in the sweetener composition can be about 0.0005 to 20% or about 0.5%. In an embodiment, the amount of salt in the sweetener composition can be about 0.002 to 1.0% or about 0.1% w/w.

In addition, the sweetener composition can include additives such as citric acid, gum arabic, olive oil, betaine (trimethylglycine), and choline (choline bitartrate, choline chloride or choline delivered through lecithin, modified lecithin or other natural sources of phospholipids). In an embodiment, the amount of citric acid in the sweetener composition can be about 0.001 to 10% w/w. In an embodiment, the amount of gum arabic in the sweetener composition can be about 5 to 50% w/w. In an embodiment, the amount of olive oil in the sweetener composition can be about 0.005 to 10% w/w. In an embodiment, the amount of betaine in the sweetener composition can be about 0.0005 to 20% or about 0.5%. In an embodiment, the amount of choline bitartrate salt in the sweetener composition can be about 0.002 to 1.0% or about 0.1% w/w. Similarly, the amount of lecithin can be 0.007 to 4.0% or about 0.5% w/w.

In addition, the sweetener composition can include additives such as citric acid, gum arabic, olive oil, betaine (trimethylglycine), and epsilon polylysine. In an embodiment, the amount of citric acid in the sweetener composition can be about 0.001 to 10% w/w. In an embodiment, the amount of gum arabic in the sweetener composition can be about 5 to 50% w/w. In an embodiment, the amount of olive oil in the sweetener composition can be about 0.005 to 10% w/w. In an embodiment, the amount of betaine in the sweetener composition can be about 0.0005 to 20% or about 0.5%. In an embodiment, the amount of epsilon polylysine in the sweetener composition can be about 0.002 to 0.1% or about 0.02% w/w.

In addition, the sweetener composition can include additives such as citric acid, gum arabic, and olive oil. In an embodiment, the amount of citric acid in the sweetener composition can be about 0.001 to 10% w/w. In an embodiment, the amount of gum arabic in the sweetener composition can be about 5 to 50% w/w. In an embodiment, the amount of olive oil in the sweetener composition can be about 0.005 to 10% w/w.

In addition, the sweetener composition can include one or more additives (one, combination of two, three, four, five, and so on) selected from: glycine, betaine, epsilon polylysine, citric acid, tartaric acid, choline bitartrate, potassium bitartrate, sodium bitartrate, sodium chloride, and potassium chloride. In an embodiment, the amounts of each of glycine, betaine, epsilon polylysine, and/or citric acid can be in amounts as described herein. In an embodiment, the amount of tartaric acid in the sweetener composition can be about 0.001 to 10% w/w. In an embodiment, the amount of choline bitartrate, potassium bitartrate, or sodium bitartrate in the sweetener composition can be about 0.001 to 10% w/w. In an embodiment, the amount of sodium or potassium chloride in the sweetener composition can be about 0.001 to 10% w/w.

In an embodiment, the sweetener composition can include an orally ingestible composition such as beverages and beverage concentrates; foods including the sweetener composition; candies, desserts, and the like including the sweetener composition; pharmaceutical compositions or the like that include the sweetener composition; and the like.

In an embodiment, the first additives (e.g., detergent-like additives) and other additives such as sugar (e.g., glucose, sucrose, and fructose), artificial sweeteners (e.g., aspartame, sucralose, saccharin, neotame, and the like), carbohydrates including psicose, polyols, salts, bitter compounds, flavorants and flavoring ingredients, astringent agents, surfactants, alcohols, and combinations thereof, described herein can be added to the orally ingestible composition separately from the sweetener composition or these additives can be added to both the orally ingestible composition and the sweetener composition. For embodiments where the additives are added directly to the orally ingestible composition, and amount of the additives used can be scaled based on the amounts noted herein that can be used in the sweetener composition. One skilled in the art would understand how to adjust the amounts of the additives provided in the sweetener compositions to determine how much to add directly to the orally ingestible composition. For example, if the sweetener composition is diluted in a beverage by 1000, then the amount of additive mentioned in regard to the sweetener composition can be reduced by a factor of 1000 and added directly to the orally ingestible composition.

Embodiments of the present disclosure contemplate that stevia sweeteners and lipid materials (e.g., oils, fatty acids and the like) in the presence of additional surfactants and emulsifiers may be added to the emulsified stevia system described above to make food ingredients and finished food products. In addition, the emulsified stevia system may be encapsulated to modify the release rate and provide protection during processing and shelf life storage. The, emulsified stevia system may be fully or partially encapsulated with water-soluble or water-insoluble materials. Some encapsulation procedures include spray drying, spray chilling, agglomeration, fluid-bed coating, coacervation, extrusion, drip nozzle, co-extrusion, annular jet co-crystallization, and other agglomerating and encapsulating techniques. Heating can be utilized during the microencapsulation to further stabilize and hydrate, bind, or solubilize the ingredients.

In an embodiment, encapsulation materials include food approved ingredients listed below and ingredients only approved for chewing gum applications. The latter include acrylic polymers and copolymers, carboxyvinyl polymer, polyamides, polystyrene, polyvinyl acetate, polyvinyl acetate phthalate, polyvinyl pyrrolidone and shellac.

Additionally, embodiments of the present disclosure relate to a composition comprising the emulsified stevia system in encapsulated processes using food grade coating materials including aqueous solutions of food grade proteins (e.g. gelatin, zein, casein, soy, whey, dairy proteins, gelatin, egg, albumin, proteins from algal, yeast or fungal sources, and hydrolyzed versions) and mixtures thereof. It can also contain coating materials from lipids, including fats, waxes, sterols, vegetable oils, fish oil and animal fats and mixtures thereof.

In an embodiment, coating materials can also contain carbohydrates and mixtures thereof including shellac, agar, alginates, a wide variety of cellulose derivatives carboxymethylcellulose, like ethyl cellulose and hydroxypropyl methyl cellulose, methylcellulose, dextrins, starches, modified starches, acacia, maltodextrin, cyclodextrins, gum arabic, guar gums, locust bean gum, carrageenan, xanthan gum gellan gum, galactomannan, pectins gum tragacanth and karaya, xyloglucan, curdlan, cereal β-glucan, soluble soybean polysaccharide, bacterial cellulose, microcrystalline cellulose, chitosan, inulin, emulsifying polymers, konjac mannan/konjac glucomannan, seed gums, and pullulan, saponins, arabanogalactomanans, beta-glucans, in all their isomeric and stereochemical configurations, in all their variations regarding quantity and quality of monomers or oligomers that constitute the hydrocolloid, in all their presentation forms, as metal, nitrogenated, phosphorated, sulfurated salts, as well all the derivatized products of the referred hydrocolloids and mixtures thereof.

Other food grade carbohydrates include reducing sugars (e.g., monosaccharide, disaccharide, trisaccharide), oligosaccharide, maltodextrin, resistant maltodextrins, starch, starch derived materials, glucose syrup, glucose syrup solids and honey. It can also include the group of food polyols and mixtures thereof (sorbitol, mannitol, xylitol, lactitol and the like).

Additionally, the emulsified stevia system may also be adsorbed onto an inert or water-insoluble material such as silicas, silicates, pharmasorb clay, sponge-like beads or microbeads, amorphous carbonates and hydroxides, including aluminum and calcium lakes. The emulsified stevia system may be modified in a multiple step process comprising any of the techniques noted.

In an embodiment, the sweetener composition can be used in beverages, broths, and beverage preparations. In an embodiment, the sweetener composition can be used in carbonated, non-carbonated, frozen, semi-frozen (“slush”), non-frozen, ready-to-drink, concentrated (powdered, frozen, or syrup), dairy, non-dairy, herbal, non-herbal, caffeinated, non-caffeinated, alcoholic, non-alcoholic, flavored, non-flavored, vegetable-based, fruit-based, root/tuber/corn-based, nut-based, other plant-based, cola-based, chocolate-based, meat-based, seafood-based, other animal-based, algae-based, calorie enhanced, calorie-reduced, and calorie-free products. The amount of sweetener composition present can vary depending on the desired sweetness and other characteristics of the product, so the amount of sweetener used can be adjusted accordingly. In an embodiment, the beverage can include the sweetener composition and water, carbonated or non-carbonated water.

In an embodiment, the sweetener composition can be used in foods and food preparations (e.g., sweeteners, soups, sauces, flavorings, spices, oils, fats, and condiments) from dairy-based, cereal-based, baked, vegetable-based, fruit-based, root/tuber/corn-based, nut-based, other plant-based, egg-based, meat-based, seafood-based, other animal-based, algae-based, processed (e.g., spreads), preserved (e.g., meals-ready-to-eat rations), and synthesized (e.g., gels) products. The amount of sweetener composition present can vary depending on the desired sweetness and other characteristics of the product, so the amount of sweetener used can be adjusted accordingly.

In an embodiment, the sweetener composition can be used in candies, confections, desserts, and snacks such as dairy-based, cereal-based, baked, vegetable-based, fruit based, root/tuber/corn-based, nut-based, gum-based, other plant-based, egg-based, meat-based, seafood-based other animal-based, algae-based, processed (e.g., spread;), preserved (e.g., meals-ready-to-eat rations), and synthesized (e.g., gels) products. The amount of sweetener composition present can vary depending on the desired sweetness and other characteristics of the product, so the amount of sweetener composition used can be adjusted accordingly.

In an embodiment, the sweetener composition can be used in prescription and over-the-counter pharmaceuticals, assays, diagnostic kits, and therapies. In an embodiment, the sweetener can be used in weight control products, nutritional supplement, vitamins, infant diet, diabetic diet, athlete diet, geriatric diet, low carbohydrate diet, low fat diet, low protein diet, high carbohydrate diet, high fat diet, high protein diet, low calorie diet, non-caloric diet, oral hygiene products (e.g., toothpaste, mouthwash, rinses, floss, toothbrushes, other implements), personal care products (e.g., soaps, shampoos, rinses, lotions, balms, salves, ointments, paper goods, perfumes, lipstick, other cosmetics), professional dentistry products in which taste or smell is a factor (e.g., liquids, chewables, inhalables, injectables, salves, resins, rinses, pads, floss, implements), medical, veterinarian, and surgical products in which taste or smell is a factor (e.g., liquids, chewables, inhalables, injectables, salves, resins, rinses, pads, floss, implements), and pharmaceutical compounding fillers, syrups, capsules, gels, and coating products. The amount of sweetener composition present can vary depending on the desired sweetness and other characteristics of the product, so the amount of sweetener composition used can be adjusted accordingly.

In an embodiment, the sweetener composition herein can be used in goods including table top sweeteners, sweeteners, co-sweeteners, coated sweetener sticks, frozen confection sticks, medicine spoons (human and veterinary uses), dental instruments, pre-sweetened disposable tableware and utensils sachets edible sachets potpourris, edible potpourris, artificial flowers, edible artificial flowers, clothing, edible clothing, massage oils, and edible massage oils. The amount of sweetener composition present can vary depending on the desired sweetness and other characteristics of the product, so the amount of sweetener composition used can be adjusted accordingly.

In an embodiment, the sweetener composition can include a tabletop sweetener composition that can optionally include bulking agent or anti-caking agent or flow agent. In an embodiment, the tabletop sweetener composition can be packaged in numerous different forms and it is intended that the tabletop sweetener compositions of the present disclosure may be of any form known in the art. In an embodiment, the tabletop sweetener composition can be in the form of powder form, granular form, packets, tablets, sachets, pellets, cubes, solids, and liquids (e.g., the sweetener composition is included in a liquid carrier).

In an embodiment, the sweetener composition is a liquid product with properties such that it can be sold commercially. In another embodiment, the liquid sweetener composition is dried through a variety of techniques known to those skilled in the art including spray drying, freeze drying and vacuum drying, and foam-mat drying, stored for up to 3 years, then re-distributed into a food product such that the original taste characteristic of the liquid product is maintained.

In another embodiment, the liquid emulsion can be made into a dry material via plating onto a carrier including food grade carbohydrates (i.e., dextrins, cyclodextrins, maltodextrins, starches, modified starches, and the like), proteins (i.e., animal, vegetable or dairy proteins, concentrates or isolates), silicas silicates, and the like, and other absorptive media.

In an embodiment, the dry materials may be used as is or as starting materials for further processing (i.e., encapsulation).

In an embodiment, the dry emulsified stevia system may be encapsulated to modify the release rate (i.e., longer lasting sweetness in chewing gum) and provide protection during processing and shelf life storage.

In another embodiment, the liquid emulsified stevia system can be directly encapsulated using processes directly based on emulsification (i.e., spray drying, glass extrusion, and coacervation) and other emulsion technologies (i.e., water-oil-water emulsions).

In another embodiment, the sweetener composition can be a mixture of solid ingredients with properties such that it can be sold commercially. The solid ingredients can be combined or exist in an uncombined fashion. In another embodiment, the sweetener composition is a mixture of solid ingredients and liquids that are dried such that the dried mixture has properties such that it can be sold commercially.

Generally, the amount of a sweetener composition (and/or additives added directly to the orally ingestible composition) in a product varies widely depending on the particular type of sweetened composition and its desired sweetness of the product. Those of ordinary skill in the art can discern the appropriate amount of sweetened composition to include in a particular product.

Now having described various embodiments of the present disclosure, the following describes additional embodiments.

An embodiment of the present disclosure provides for a method of reducing oral cavity and tongue coating adherence and tongue numbing effects of a sweetener composition, comprising: providing to a person a sweetener composition that includes a high potency sweetener, wherein the high potency sweetener is included in an emulsified mixture. In an embodiment, the high potency sweetener is selected from the group consisting of: mogroside IV, mogroside V, Luo Han Guo sweetener, siamenoside, monatin and its salts (monatin SS, RR, RS, SR), curculin, glycyrrhizic acid and its salts, thaumatin, monellin, mabinlin, brazzein, hernandulcin, phyllodulcin, glycyphyllin, phloridzin, trilobatin, baiyunoside, osladin, polypodoside A, pterocaryoside A, pterocaryoside B, mukurozioside, phlomisoside I, periandrin I, abrusoside A, cyclocarioside I, and modification or derivatives thereof.

An embodiment of the present disclosure provides for a method of imparting a more sugar-like temporal and flavor profile to a high potency sweetener, comprising: providing to a person a sweetener composition that includes a high potency sweetener, wherein the high potency sweetener is included in an emulsified mixture. In an embodiment, the high potency sweetener is selected from the group consisting of: mogroside IV, mogroside V, Luo Han Guo sweetener, siamenoside, monatin and its salts (monatin SS, RR, RS, SR), curculin, glycyrrhizic acid and its salts, thaumatin, monellin, mabinlin, brazzein, hernandulcin, phyllodulcin, glycyphyllin, phloridzin, trilobatin, baiyunoside, osladin, polypodoside A, pterocaryoside A, pterocaryoside B, mukurozioside, phlomisoside I, periandrin I, abrusoside A, cyclocarioside I, and modification or derivatives thereof.

An embodiment of the present disclosure provides for a method of imparting a more sugar-like temporal and flavor profile to a high potency sweetener, comprising: providing to a person a sweetener composition that includes an encapsulated high potency sweetener. In an embodiment, the high potency sweetener is selected from the group consisting of: mogroside IV, mogroside V, Luo Han Guo sweetener, siamenoside, monatin and its salts (monatin SS, RR, RS, SR), curculin, glycyrrhizic acid and its salts, thaumatin, monellin, mabinlin, brazzein, hernandulcin, phyllodulcin, glycyphyllin, phloridzin, trilobatin, baiyunoside, osladin, polypodoside A, pterocaryoside A, pterocaryoside B, mukurozioside, phlomisoside I, periandrin I, abrusoside A, cyclocarioside I, and modification or derivatives thereof.

An embodiment of the present disclosure provides for a sweetener composition comprising the following components: at least one high potency sweetener; at least one oil; and optionally, at least one hydrocolloidal material, wherein the mixture of components is a stabilized hydrocolloidal system.

In an embodiment, the high potency sweetener is selected from the group consisting of: mogroside IV, mogroside V, Luo Han Guo sweetener, siamenoside, other components of Luo Han Guo sweetener, monatin and its salts (monatin SS, RR, RS, SR), curculin, glycyrrhizic acid and its salts, thaumatin, monellin, mabinlin, brazzein, hernandulcin, phyllodulcin, glycyphyllin, phloridzin, trilobatin, baiyunoside, osladin, polypodoside A, pterocaryoside A, pterocaryoside B, mukurozioside, phlomisoside I, periandrin I, abrusoside A, cyclocarioside I, modification or derivatives thereof, and a combination thereof.

In an embodiment, the high potency sweetener is selected from the group consisting of: steviolbioside, stevioside, rebaudioside A, rebaudioside B, rebaudioside C, rebaudioside D, rebaudioside E, rebaudioside F, rebaudioside M/X, rubusoside, dulcoside A, dulcoside B, and a combination thereof.

In an embodiment, the oil is a food acceptable oil. In an embodiment, the oil is selected from the group consisting of: a soybean oil, a coconut oil, a palm oil, a palm oil fraction, a cotton seed oil, a canola oil, an olive oil, a sunflower oil, a high oleic sunflower oil, a safflower oil, olive oil and a combination thereof.

In an embodiment, the colloidal material is selected from the group consisting of: lecithin, chitosan, starch and modified starches including purity gum, cross-linked starch, sodium starch glycolate, pregelatinated starch and non-pregelatinated starch including starch from corn, potato, tapioca, wheat, and rice, pectin, agar, carageenan, furcellaran, fibers, dextran, gums, xanthan gums, alginic acids, alginates and derivatives thereof, cellulose, cellulose gum and derivatives thereof including microcrystalline cellulose (MCC), methyl cellulose (MC), carboxy methyl cellulose, hydroxy methyl cellulose, hydroxy ethyl cellulose, hydroxy propyl cellulose, and cellulose ethers including hydroxy propyl methyl cellulose (HPMC), polyethylene oxide, acetic acid esters of monogylcerides (ACTEM), lactic acid esters of monogylcerides (LACTEM), citric acid esters of monogylcerides (CITREM), diacetyl acid esters of monoglycerides (DATEM), succinic acid esters of monogylcerides, polyglycerol polyricinoleate, sorbitan esters of fatty acids, propylene glycol esters of fatty acids, sucrose esters of fatty acids, mono and diglycerides, fruit acid esters, stearoyl lactylates, polysorbates, starches, sodium dodecyl sulfate (SDS), stearic acid, palmitic acid, polyglycerol esters, stearoyl-2-lactylates, succinylated monoglycerides, ethoxylated monoglycerides, various types of hydrocolloid-based polymers and a combination thereof.

In an embodiment, the colloidal material is a macromolecule including proteins selected from milk proteins, wheat proteins, pea proteins, soy proteins, buckwheat proteins, carob proteins, barley proteins, oat proteins, rice proteins, rye proteins, gelatin, whey proteins, algae, yeast, fungus, and combinations thereof, or an edible fiber.

In an embodiment, the colloidal material is an edible fiber selected from the group consisting of: sugar beet fiber, apple fiber, pea fiber, wheat fiber, oat fiber, barley fiber, rye fiber, rice fiber, potato fiber, tomato fiber, other plant non-starch polysaccharide fibers, and combinations thereof.

In an embodiment, the gum is selected from the group consisting of: locust bean gum, gum arabic, guar gum, gellan gum, gum ghatti, karaya gum, locust bean gum, tragacanth gum, xanthan gum, pectin, purity gum, modified starch, quillaia extract, and a combination thereof.

In an embodiment, the colloidal material is selected from the group consisting of: lecithin, refined lecithin, modified lecithin, sources of choline, sources of phospholipids, succinylated monoglycerides, ethoxylated monoglycerides including those produced from castor oil.

In an embodiment, the macromolecule is selected from the group consisting of milk protein, whey protein, pea protein, gelatin, whey protein, sugar beet fiber, apple fiber, pea fiber, oat fiber, barley fiber, and a combination thereof.

In an embodiment, the oil is a flavoring oil.

In an embodiment, the oil is selected from the group consisting of: a citrus oil, citrus byproduct, modified citrus byproduct, a turpentine oil, turpentine byproduct, modified turpentine byproduct, a citrus oil, citrus byproduct, modified citrus byproduct, a mint oil, mint byproduct or modified mint byproduct, a cinnamon/cassia oil, cinnamon/cassia oil byproduct, or modified cinnamon/cassia oil byproduct, or a ginger oil, ginger byproduct, or modified ginger byproduct.

In an embodiment, the oil is an aroma chemical.

In an embodiment, the aroma chemical is selected from the group consisting of: anethole, benzyl alcohol and its esters, citronellol and its esters, geraniol/nerol and its esters, 1-menthol and its esters, or alpha terpineol and its esters, or benzaldehyde, limonene, monoterpenes, and diterpenes.

In an embodiment, the sweetener composition include a first additive.

In an embodiment, the first additive is selected from the group consisting of: alkyl sulfonates, alkyl phosphates, alkyl sulfates, O-alkyl sugars, amino acids, N-alkyl amino acids, and polyamino acids.

In an embodiment, the first additive is selected from the group consisting of: choline bitartrate, choline chloride, another choline salt or other source of choline or combinations thereof.

In an embodiment, the first additive is selected from the group consisting of: a dicarboxylic acid, tricarboxylic acid, aldonic acid, aldaric acid, alpha-hydroxy acid or salt thereof.

In an embodiment, the first additive is selected from the group consisting of: glyceric acid, gluconic acid, ascorbic acid, tartaric acid, galactaric acid, citric acid, isocitric acid or salts thereof, alpha hydroxyl acid, and combinations thereof.

In an embodiment, the stabilized colloidal system is formed by forming an emulsion of the high potency sweetener, the oil, and the colloidal material.

In an embodiment, the emulsion is formed by shaking, stirring, homogenizing, high pressure pulverization, heating, sonication and combinations thereof, of the mixture of the high potency sweetener, the oil, and the colloidal material.

In an embodiment, the at least one high potency sweetener is encapsulated.

In an embodiment, the stabilized hydrocolloidal system is encapsulated.

An embodiment of the present disclosure includes a beverage product, comprising water and a sweetener composition, wherein the sweetener composition includes the following components: at least one high potency sweetener, at least one oil, and optionally, at least one hydrocolloidal, wherein the mixture of components is a stabilized hydrocolloidal system.

In an embodiment, the water is carbonated.

In an embodiment, the water is non-carbonated.

An embodiment of the present disclosure provides for a food product, comprising a sweetener composition, wherein the sweetener composition includes the following components: at least one high potency sweetener, at least one oil, and optionally, at least one hydrocolloidal, wherein the mixture of components is a stabilized hydrocolloidal system.

An embodiment of the present disclosure provides for a table top sweetener, comprising a sweetener composition, wherein the sweetener composition includes the following components: at least one high potency sweetener, at least one oil, and optionally, at least one hydrocolloidal, wherein the mixture of components is a stabilized hydrocolloidal system.

An embodiment of the present disclosure provides for a method of improving the sweetness of a sweetener composition, comprising: providing to a person a sweetener composition that includes a high potency sweetener, wherein the high potency sweetener is included in an emulsified mixture.

In an embodiment, the emulsified mixture is encapsulated.

An embodiment of the present disclosure provides for a method of making a sweetener composition, comprising: emulsifying a mixture including a high potency sweetener.

In an embodiment, the mixture further includes at least one oil and at least one colloidal material.

In an embodiment, wherein the method further comprises a sweetener composition that includes an amine additive or combination thereof.

In an embodiment, wherein the method further comprises a sweetener composition that includes an aldaric acid additive or combination thereof.

In an embodiment, wherein the method further comprises a sweetener composition that includes a combination of amine and aldaric acid additives.

An embodiment of the present disclosure provides a beverage product, comprising water and a sweetener composition, wherein the sweetener composition includes the following components: at least one high potency sweetener, at least one oil, and optionally, at least one hydrocolloidal material, wherein the mixture of components is a stabilized hydrocolloidal system.

An embodiment of the present disclosure provides a sweetener composition comprising the following components: at least one high potency sweetener; at least one oil; and optionally, at least one hydrocolloidal material, wherein the mixture of components is a stabilized hydrocolloidal system.

In an embodiment, the beverage product can include water that is carbonated or non-carbonated.

In an embodiment of the beverage product or the sweetener composition, the stabilized hydrocolloidal system is formed by forming an emulsion of the high potency sweetener, the oil, and the hydrocolloidal material.

In an embodiment of the beverage product or the sweetener composition, further comprises: an amine additive, wherein the amine additive is selected from the group consisting of: alkyl amine, alkyl diamines, alkyl triamines, and a combination thereof.

In an embodiment of the beverage product or the sweetener composition, the amine additive is selected from the group consisting of: glycine, trimethylglycine, and a combination thereof.

In an embodiment of the beverage product or the sweetener composition, further comprises a first additive.

In an embodiment of the beverage product or the sweetener composition, the first additive is selected from the group consisting of: alkyl sulfonates, alkyl phosphates, alkyl sulfates, O-alkyl sugars, amino acids, N-alkyl amino acids, polyamino acids, polyamino acid salts and a combination thereof.

In an embodiment of the beverage product or the sweetener composition, the first additive is selected from the group consisting of: inorganic salts including halides, particularly chlorides including those formed from sodium, potassium, calcium, magnesium, zinc, iron, ammonium (NH₄⁺) and pyridinium.

In an embodiment of the beverage product or the sweetener composition, the first additive is selected from the group consisting of: glyceric acid or a salt thereof, gluconic acid or a salt thereof, ascorbic acid or a salt thereof, tartaric acid or a salt thereof, galactaric acid or a salt thereof, citric acid or a salt thereof, isocitric acid or a salt thereof, and a combination thereof.

In an embodiment of the beverage product or the sweetener composition, the lipid is selected from the group consisting of: a soybean oil, a coconut oil, a palm oil, a palm oil fraction, a cotton seed oil, a canola oil, an olive oil, a sunflower oil, a high oleic sunflower oil, a safflower oil, olive oil and a combination thereof.

In an embodiment of the beverage product or the sweetener composition, the lipid is selected from the group consisting of flavors oil or aroma chemicals: essential or modified essential oil of lemon, orange, lime, bergamot, mint, cinnamon, cassia, ginger, a fraction of the oil or a modified processing byproduct of any of the preceding, anethole, benzyl alcohol and its esters, citronellol and its esters, geraniol/nerol and its esters, 1-menthol and its esters, or alpha terpineol and benzaldehyde.

In an embodiment of the beverage product or the sweetener composition, the lipid is selected from the group consisting of marine oil, animal fat including milkfat and mineral oil.

In an embodiment of the beverage product or the sweetener composition, the sweetener composition includes the hydrocolloidal material, wherein the hydrocolloidal material is selected from the group consisting of: lecithin, chitosan, starch and modified starches, cellulose, cellulose gum and derivatives thereof, polyethylene oxide, acetic acid esters of monogylcerides (ACTEM), lactic acid esters of monogylcerides (LACTEM), citric acid esters of monogylcerides (CITREM), diacetyl acid esters of monoglycerides (DATEM), succinic acid esters of monogylcerides, polyglycerol polyricinoleate, sorbitan esters of fatty acids, propylene glycol esters of fatty acids, sucrose esters of fatty acids, mono and diglycerides, fruit acid esters, stearoyl lactylates, polysorbates, starches, sodium dodecyl sulfate (SDS), stearic acid, palmitic acid, polyglycerol esters, stearoyl-2-lactylates, succinylated monoglycerides, ethoxylated monoglycerides, various types of hydrocolloid-based polymers and a combination thereof.

In an embodiment of the beverage product or the sweetener composition, the sweetener composition includes the hydrocolloidal material, wherein the hydrocolloidal material is a macromolecule selected from the group consisting of: milk proteins, wheat proteins, pea proteins, soy proteins, buckwheat proteins, carob proteins, barley proteins, oat proteins, rice proteins, rye proteins, gelatin, whey proteins, algae, yeast, fungus, and a combination thereof.

In an embodiment of the beverage product or the sweetener composition, the sweetener composition includes the hydrocolloidal material, wherein the hydrocolloidal material is an edible fiber selected from the group consisting of: sugar beet fiber, apple fiber, pea fiber, wheat fiber, oat fiber, barley fiber, rye fiber, rice fiber, potato fiber, tomato fiber, plant non-starch polysaccharide fibers, and a combination thereof.

In an embodiment of the beverage product or the sweetener composition, the sweetener composition includes the hydrocolloidal material, wherein the hydrocolloidal material is a gum is selected from the group consisting of: locust bean gum, gum arabic, guar gum, gellan gum, gum ghatti, karaya gum, locust bean gum, tragacanth gum, xanthan gum, pectin, purity gum, modified starch, quillaia extract, and a combination thereof.

In an embodiment of the beverage product or the sweetener composition, the hydrocolloidal material is gum arabic, purity gum, modified food starch and/or pectin.

In an embodiment of the beverage product or the sweetener composition, the sweetener composition includes the hydrocolloidal material, wherein the hydrocolloidal material is selected from the group consisting of: lecithin, refined lecithin, modified lecithin, a source of choline, a source of phospholipids, succinylated monoglycerides, ethoxylated monoglycerides including those produced from castor oil.

In an embodiment of the beverage product or the sweetener composition, the high potency sweetener is selected from the group consisting of: mogroside IV, mogroside V, Luo Han Guo sweetener, siamenoside, other components of Luo Han Guo sweetener, monatin and its salts (monatin SS, RR, RS, SR), curculin, glycyrrhizic acid and its salts, thaumatin, monellin, mabinlin, brazzein, hernandulcin, phyllodulcin, glycyphyllin, phloridzin, trilobatin, baiyunoside, osladin, polypodoside A, pterocaryoside A, pterocaryoside B, mukurozioside, phlomisoside I, periandrin I, abrusoside A, cyclocarioside I, modification or derivatives thereof, steviolbioside, stevioside, rebaudioside A, rebaudioside B, rebaudioside C, rebaudioside D, rebaudioside E, rehaudioside F, rehaudioside M/X, rubusoside, dulcoside A, dulcoside B, and a combination thereof.

In an embodiment of the beverage product or the sweetener composition, the at least one high potency sweetener is encapsulated or wherein the stabilized hydrocolloidal system is encapsulated.

### EXAMPLES

Prior to describing the Examples in detail, a formulation study ballot will be described that illustrates how samples are evaluated.

Instructions:

Nearly all high-potency (HP) sweeteners, exhibit a sweetness which is delayed in onset, which can be quantified as sweetness Appearance Time (AT), and which then lingers significantly, which can be quantified as sweetness Extinction Time (ET). In addition, steviol glycosides, when evaluated at ambient temperature, exhibit low maximal responses (i.e., Rₘ</=10% SE), negative taste attributes (e.g., bitterness) as well as sweetness desensitization sometimes characterized as “mouth-coating” or “tongue-numbing”. Tongue numbing can also manifest itself as “tongue tingling”. These non-sugar-like characteristics appear inter-related in the sense that formulation as well as temperature changes affect the perception of several of them. Another taste characteristic of steviol glycosides, particularly those with relatively low levels of REB A, is soapiness, a characteristic that results from the surfactant portion of the molecule. To quantify all of these sensory effects by existing methods would require an expert sensory panel and at least 4 different sensory tests (i.e., C/R Function Determination, Flavor Profile Analysis, Temporal Profile Analysis and Adaptation Profile Analysis). However, to address a need for rapid screening of HP sweetener formulations, Prakash et al., described a scaling technique to quantify all of these sensory percepts in a single test (reference shown below under the table). An improvement of this methodology is described below.

Prior to the evaluation of test samples, all panelists must first calibrate themselves on Sucrose and Reference Samples (e.g., REB A) to ensure that they are able to appropriately scale taste attributes of interest. These Reference Samples are to be available in ample quantities for all experimental sessions. The Sucrose Reference is 10.0% sucrose acidified with 0.1% citric acid. For illustration purposes, an example of a Reference Sample can be a REB A Reference Sample that has 500 PPM REB A in the same system for general formula optimization studies.

Subjects are to calibrate themselves to the references by the following procedure:

Reference Sample Calibration:

Take a ca. 15 mL sample of the Sucrose Reference into the mouth swishing it around vigorously and note all attributes of the sensory experience. After ca. 10 sec, expectorate the sample and immediately rinse vigorously with ca. 15 mL of water, expectorating the rinse water. Over the next 2 minutes, while minimizing tongue movement in the mouth, pay attention to any rebound or intensification in perceived sweetness, bitterness, or numbing/tingling sensation. The intensity of the attribute perceived at 2 minutes is an estimate of its lingering tendency. Upon completion of calibration with the Sucrose Reference, calibration with the REB A Reference is carried out in the same way. The attribute ratings for the Sucrose and REB A References, all on 0-15 scales, are defined as follows:

| | Sucrose | REB A100 |
|---|---|---|
| Attribute | Reference | Reference |
| Sweetness Intensity Initial | 10 | 10 |
| (Sweetness) | | |
| Sweetness Onset/Appearance | 0 | 3 |
| Time (Onset) | | |
| Bitterness Intensity (I_{B}) | 0 | 3 |
| Astringency Intensity | 0 | 0 |
| (Astring) | | |
| Mouthfeel (Mfeel) | 10 | 0 |
| Soapiness (Soap) | 0 | 1 |
| Numbing/Tingling Sensation | 0 | 0 |
| (Numb/Ting) | | |
| Sweetness Intensity @ 2 Min | 0 | 3 |
| (Sweet2) | | |
| Bitterness Intensity @ 2 Min | 0 | 2 |
| (Bitter2) | | |
| Numbing/Tingling Sensation | 0 | 2 |
| @ 2 Min (Numb/Ting2) | | |

I. Prakash, G. DuBois, P. Jella, G. A. King, R. I. San Miguel, K. H. Sepcic, D. K. Weerasinghe and N. R. White, “Natural High-Potency Sweetener Compositions with Improved Temporal Profile and/or Flavor Profile, Methods for their Formulation and Uses”, US Patent Application 2007/0128311 A1 (Jun. 7, 2007).

After completion of reference sample calibrations, as well as in follow up of all sample tests, rinse the mouth vigorously with ca. 15 mL portions of the Sucrose Reference solution and two ca. 15 mL portions of water in effort to get the sensory system back to baseline. Do not proceed to the next sample until no sweetness remains in the mouth.

Test Sample Evaluations:

After calibration with the Sucrose Reference and REB A Reference, evaluate all experimental samples by the same protocol, always using the Sucrose Reference and water rinse procedure and ensuring adequate time for the sensory system to return to normal before proceeding with subsequent samples

### Example 1

A purpose of this example is to illustrate, in non-carbonated soft drinks, the reduction in adherence of REB A100 to the tongue and oral cavity due to the addition of gum arabic and further reduced at a surprisingly low level of trace amines. Reduction in adherence is understood through reduced lingering behavior of attributes, particularly numbing/tingling, and reduced initial numbing/tingling effect.

Sample preparation: all beverages were prepared using beverage standard carbon filtered water which was free from off-taste due to organic or inorganic materials. All samples were acidified with 0.1% citric acid and contained 500 mg/L REB A100 from Almendra Pte. All additives were food grade materials. Betaine was purchased from NOW Foods Corporation and used at a concentration of 75 ppm. Epsilon polylysine was received from JNC Corporation and used at a concentration of 12.5 ppm. Gum arabic purchased from TIC gums and used at a concentration of 5000 mg/L. Beverages were held for 24 hours at room temperature prior to evaluation at room temperature.

Taste procedure: the beverages were evaluated in triplicate using the sensory methodology described herein by four trained expert panelists and mean values were used for data analysis.

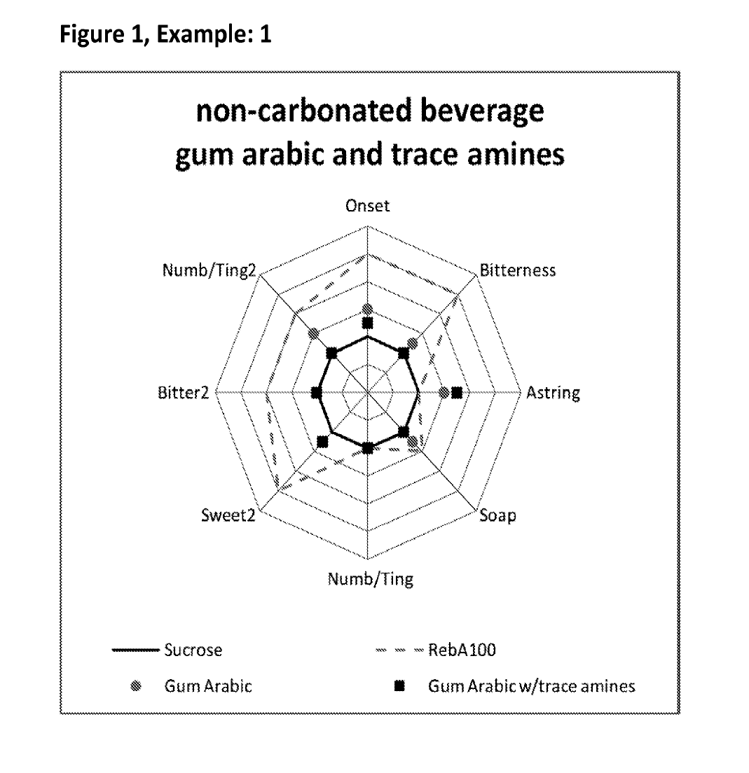

Test results: As shown in FIG. 1 spidergraph, the beverages with gum arabic shows greatly improved taste on all attributes except astringency. The beverage with emulsified gum arabic and trace additives (betaine and epsilon polylysine) shows a further improved taste corresponding to rating differences of 0.5-1, with respect to all lingering plus sweetness onset and bitterness. No treatment perfectly simulated the taste profile of sugar.

### Example 2

A purpose of this example is to illustrate, in non-carbonated soft drinks, the improvement of reduction in adherence of REB A100 to the tongue and oral cavity due to its delivery in a preparation of an oil in water emulsion of REB A100. In particular, this experiment shows that the introduction of energy and subsequent stabilization of the colloidal system produces a superior effect relative to any effect that the individual components of the emulsifier can produce. As in example 1, reduction in adherence is understood through reduced lingering behavior of attributes, particularly numbing/tingling, and reduced initial numbing/tingling effect.

Sample preparation: all beverages were prepared using beverage standard carbon filtered water which was free from off-taste due to organic or inorganic materials. All samples were acidified with 0.1% citric acid and contained 500 mg/L REB A100 from Almendra Pte. All additives were food grade materials and of the same origin and concentration as in example 1. The oil was extra virgin olive oil and used at levels of 1.0%, 0.5% and 0.1% in the emulsion. The corresponding beverage concentrations were 200 mg/L, 100 mg/L and 20 mg/L. Gum arabic was allowed to hydrate for one hour prior to the addition of oil and processing. Emulsions were processed using a waring type blender on high speed for 1 minute. Beverages containing olive oil only were processed under the same conditions as the emulsions. Beverages were held for 24 hours at room temperature prior to evaluation at room temperature.

Taste procedure: the beverages were evaluated in triplicate using the sensory methodology described herein by four trained expert panelists and mean values were used for data analysis.

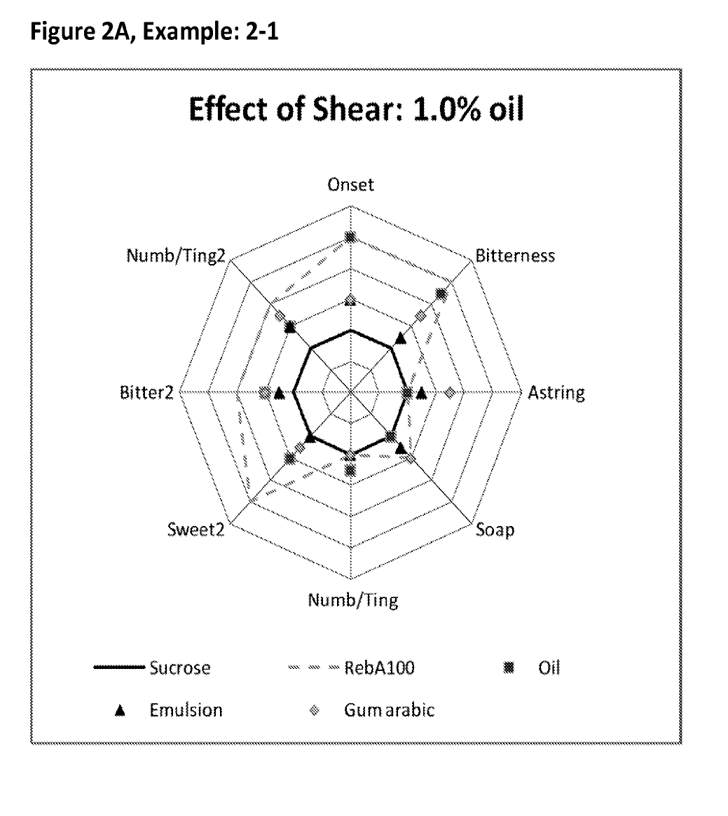

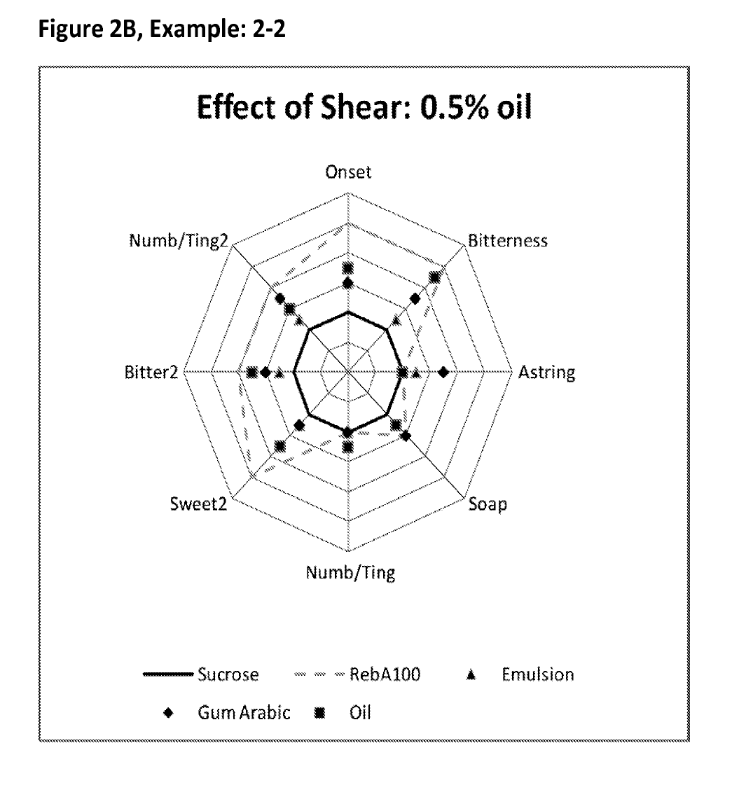

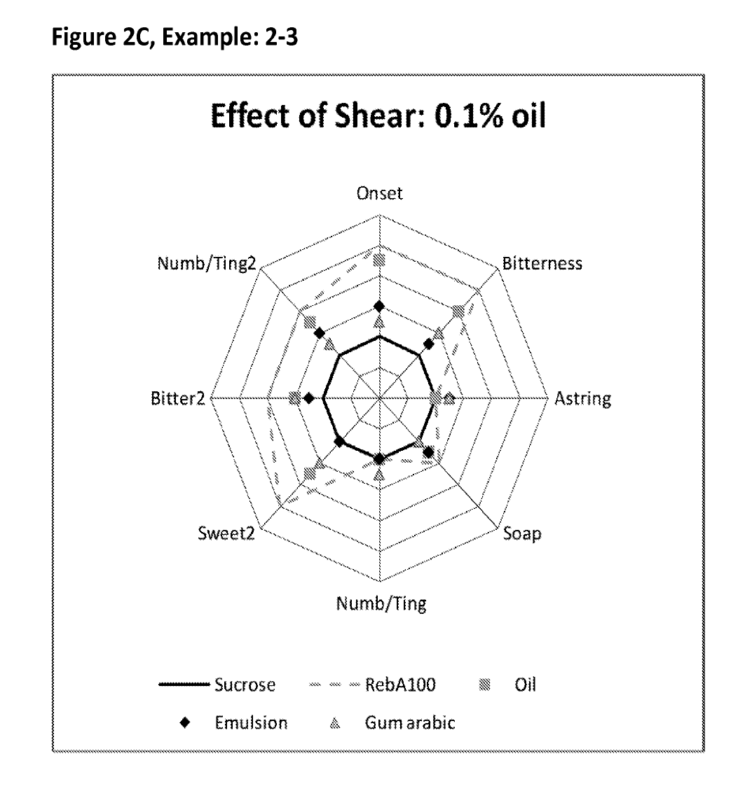

Test results: As shown in FIG. 2A-2C spidergraphs, the beverages with emulsified gum arabic shows greatly improved taste on all attributes than their counterparts containing only gum arabic or only olive oil. This is validated at 3 different oil levels for the important attributes of lingering numbness/tingling, sweetness and bitterness. No treatment perfectly simulated the taste profile of sugar.

### Example 3

A purpose of this example is to illustrate, in non-carbonated soft drinks, the reduction in adherence of REB A100 to the tongue and oral cavity due to the addition of gum arabic and, surprisingly, further reduced with the addition of trace levels of amines. Reduction in adherence is understood through reduced lingering behavior of attributes, particularly numbing/tingling, and reduced initial numbing/tingling effect.

Sample preparation: all beverages were prepared using beverage standard carbon filtered water which was free from off-taste due to organic or inorganic materials. All samples were acidified with 0.1% citric acid and contained 500 mg/L REB A100 from Almendra Pte. All additives were of the same origin as described above and used at the same concentrations as above. Emulsions were processed as above. Beverages were held for 24 hours at room temperature prior to evaluation at room temperature.

Taste procedure: the beverages were evaluated in triplicate using the sensory methodology described herein by four trained expert panelists and mean values were used for data analysis.

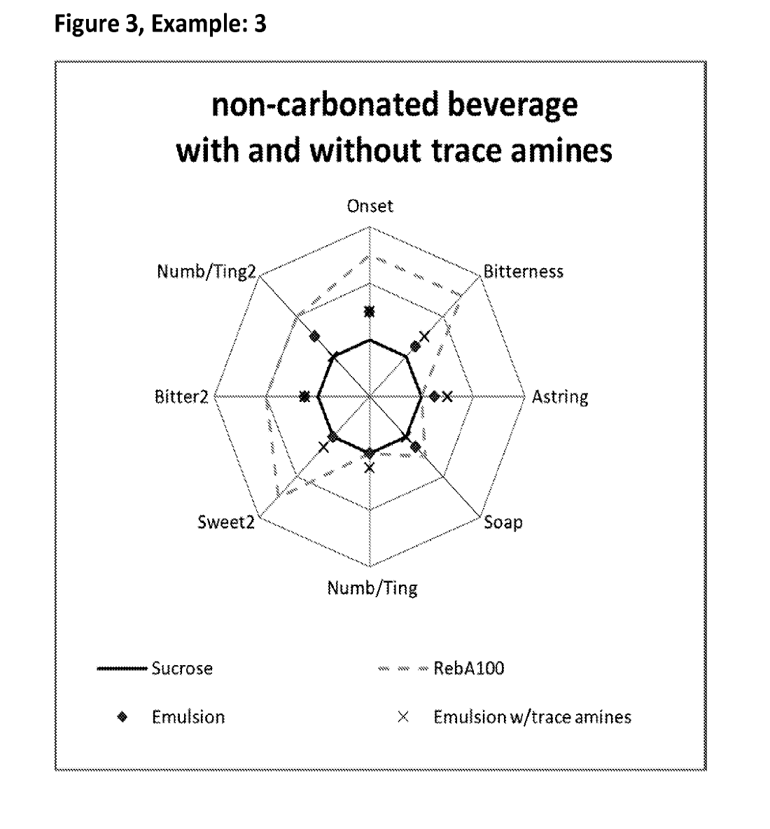

Test results: As shown in FIG. 3 spidergraph, the sweet taste improvement is further is significantly enhanced by the presence of trace amines (betaine and epsilon polylysine) in the area of lingering sweetness and numbness/tingling.

### Example 4

A purpose of this example is to illustrate, in non-carbonated soft drinks, the reduction in adherence of REB A100 to the tongue and oral cavity due to the addition of glycine (6000 ppm) and, surprisingly, that it is further improved by the addition of trace levels of amines (betaine at 75 mg/L and epsilon polylysine at 12.5 mg/L).

Sample preparation: all beverages were prepared using beverage standard carbon filtered water which was free from off-taste due to organic or inorganic materials. All samples were acidified with 0.1% citric acid and contained 500 mg/L REB A100 from Almendra Pte. All additives were of the same origin as described above. Emulsions were processed as above. Beverages were held for 24 hours at room temperature prior to evaluation at room temperature.

Taste procedure: the beverages were evaluated in triplicate using the sensory methodology described herein by four trained expert panelists and mean values were used for data analysis.

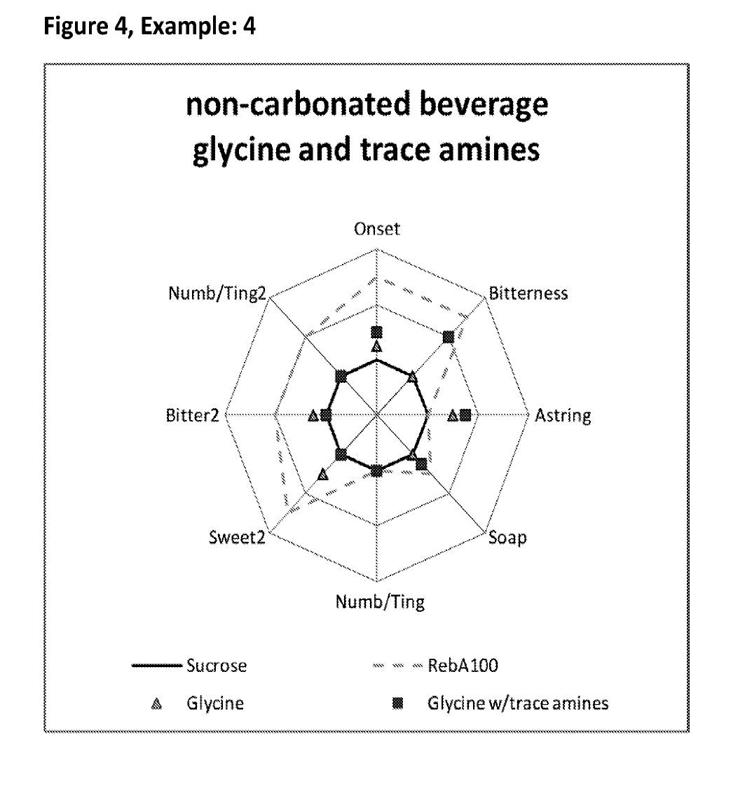

Test results: As shown in FIG. 4 spidergraph, both test beverages show greatly improved taste with respect to all taste attributes, particularly the lingering attributes of sweetness, bitterness, and numbing/tingling and also sweetness onset. The sweet taste improvement is further enhanced by the presence of trace amines in the critical area of lingering sweetness and bitterness. No treatment perfectly simulated the taste profile of sugar.

### Example 5

The purpose of this example is to illustrate, in non-carbonated soft drinks, the reduction in adherence of REBA100 to the tongue and oral cavity due to the addition of trace amines (betaine at 75 mg/L), glycine at 1000 mg/L, and choline bitartrate at 200 mg/L. Reduction in adherence is understood through reduced lingering behavior of attributes, particularly numbing/tingling, and reduced initial numbing/tingling effect.

Sample preparation: all beverages were prepared using beverage standard carbon filtered water which was free from off-taste due to organic or inorganic materials. All samples contained 12% cranberry juice from concentrate, 30% apple juice from concentrate, 243 mg/L REBA100 from Almendra Pte with the exception of the sucrose control which contained sucrose, 7% w/w, purchased from Publix. All samples were acidified with added citric acid to a titratable acidity of 0.22% and buffered with 0.3% sodium citrate. Beverages were held for 24 hours at room temperature prior to evaluation at room temperature.

Taste procedure: the beverages were evaluated in triplicate using the sensory methodology described above by four trained expert panelists and mean values were used for data analysis.

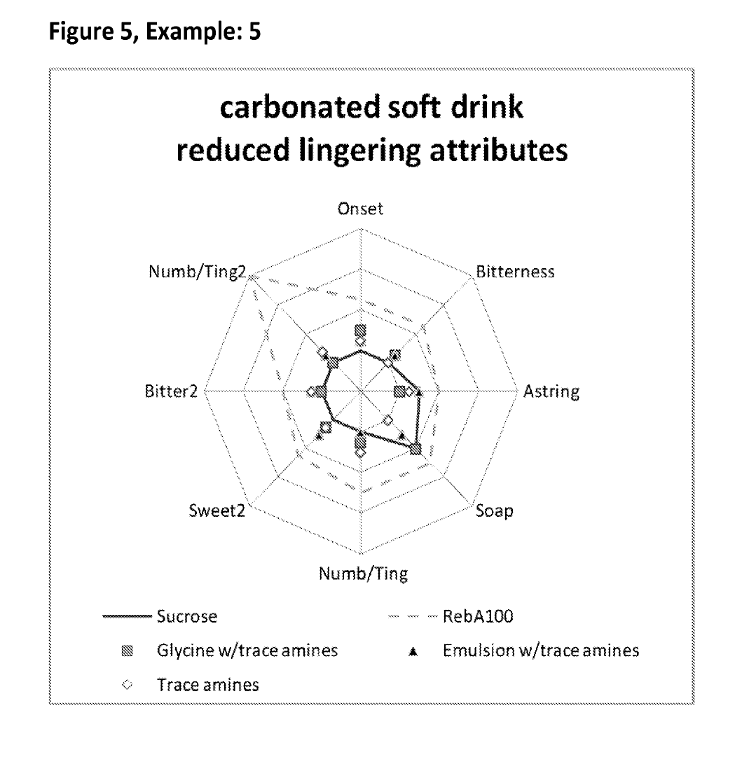

Test results: As shown in FIG. 5 spidergraph, relative to the beverage sweetened only with fruit juice and Reb A, the beverage with additives show greatly improved taste with respect to all taste attributes, and reduced sweetness linger and bitterness compared to the fruit juice and sucrose sweetened control.

### Example 6

The purpose of this example is to illustrate, in non-carbonated soft drinks, the stability of the sweetness improvements achieved in example 2, 0.1% oil level. The beverages were stored at 70-80 F for up to six months. They were re-evaluated by the same sensory panel using the same sensory method at 3 and 6 months intervals.

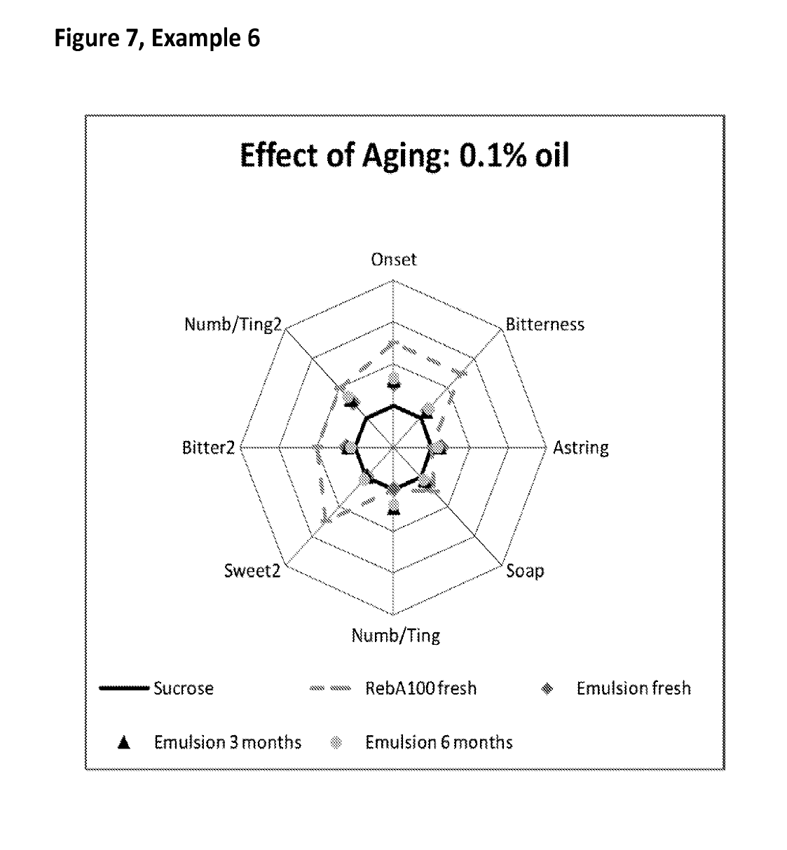

Test results: As shown in FIG. 7 spidergraph, there is no significant change in the taste profile through six months of age.

### Example 7

The purpose of this example is to illustrate, in carbonated soft drinks, the reduction in adherence of REBA100 to the tongue and oral cavity due to the addition of trace amines (betaine at 75 mg/L and epsilon polylysine at 12.5 mg/L), the emulsification of REBA100, the addition of trace amines (as above) to emulsified REBA100, and the addition of trace amines (as above) to glycine. Reduction in adherence is understood through reduced lingering behavior of attributes, particularly numbing/tingling, and reduced initial numbing/tingling effect.

Sample preparation: all beverages were prepared using beverage standard carbon filtered water which was free from off-taste due to organic or inorganic materials. All samples were acidified with 1.5% citric acid, buffered with 0.3% sodium citrate and contained 500 mg/L REBA100 from Almendra Pte with the exception of the sucrose control which contained sucrose, 10.6% w/w, purchased from Publix. All samples were flavored with 2.0 g/L lemon-lime flavor from Takasago. An intermediate step of concentrated syrup preparation was used to allow carbonation through the addition of carbonated water. The carbonation level of the beverages was approximately 3.7 volumes. The emulsion contained 1.0% w/w olive oil and was prepared as in example 2 above. Beverages were held for 24 hours at room temperature prior to evaluation at room temperature.

Taste procedure: the beverages were evaluated in triplicate using the sensory methodology described above by four trained expert panelists and mean values were used for data analysis. No more than 5 were evaluated in a single session to limit sensory fatigue.

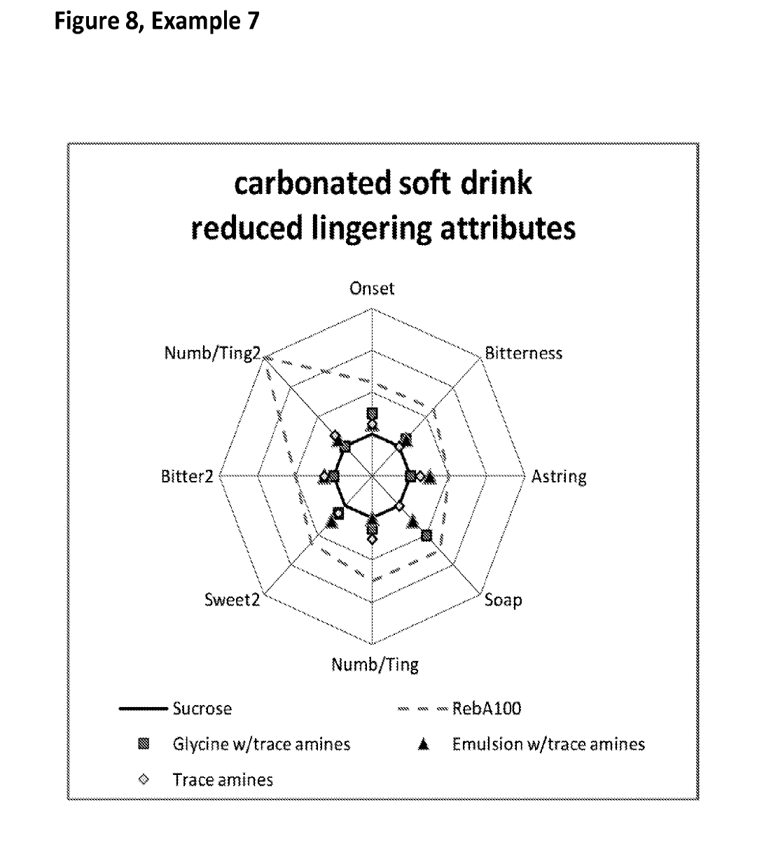

Test results: As shown in FIG. 8 spidergraph, all beverages show greatly improved taste with respect to all taste attributes, particularly the lingering attributes of sweetness, bitterness, and numbing/tingling. Trace amines alone were effective on many attributes; however, the effect of their addition initial numbing was evident. This effect was not observed in non-carbonated beverage tests (see example 2). No treatment perfectly simulated the taste profile of sugar.

### Example 8

The purpose of this example is to illustrate reduction in adherence of REBA100 to the tongue and oral cavity due to encapsulation. The encapsulation is achieved using an layer-by-layer (LBL) electrostatic deposition technique to produce a multilayered emulsion then dried using traditional spray drying techniques. Although not intended to be bound by theory, the end result may be that the hydrophobic end of Reb A is directed into the oil/lipid droplet and the hydrophilic end is attached to the disintegrant molecules pectin and gum arabic or maltodextrin, to further facilitate release from the taste receptor cells and other epithelial cells, eliminating non-specific binding. LBL emulsions are known to be more stable than conventional emulsions in food against environmental stresses such as heating, chilling, freezing, drying, pH or ionic strength variation, and aging that occur during manufacture, storage, transport, and utilization. This makes an ideal food ingredient for manufacture and sale.

Sample preparation: An aqueous emulsifier solution was prepared using 0.5% pectin, 0.5% gum arabic, 5% Reb A and 200 mg/L sodium benzoate (preservative) then and acidified to pH 3.4 with citric acid. It was held for 12 hours to ensure hydration of hydrocolloids. A Silverson L4RT mixer was used at 17,500 rpm for 2 minutes to prepare pre-emulsion. It was further processed using a Microfluidizer using 15,000 psi, 2 passes with a particle size between 0.5 and 1 micron as measured by Malvern Mastersizer. The emulsions were dried with a laboratory scale spray-drier equipped with a 0.5 mm nozzle (mini spray-dryer B-290 BUCHI, Switzerland). Emulsions were pumped into the spray-drier at room temperature and dried at an inlet temperature of 180 C and an outlet temperature of 90 C.

The same procedure was followed to produce a similar emulsion with maltodextrin replacing gum arabic.

Beverages were prepared using the encapsulates. All beverages were prepared using beverage standard carbon filtered water which was free from off-taste due to organic or inorganic materials. All samples were acidified with 0.1% citric acid and contained 500 mg/L REBA100 from Almendra Pte. All ingredients were of the same origin as described above plus pectin, HM-Vis purchased from CP Kelco and maltodextrin DE 28 was purchased from Roquette. Emulsions were processed as above. Beverages were held for 24 hours at room temperature prior to evaluation at room temperature.

Taste procedure: the beverages were evaluated in triplicate using the sensory methodology described above by four trained expert panelists and mean values were used for data analysis.

Test results: the encapsulates tasted nearly identical to sucrose on all attributes.

Another purpose of this example is to illustrate reduction in adherence of REBA100 to the tongue and oral cavity due to that results in the sweetness improvements shown in examples 2, 5 and 7 result in a more sugar-like taste profile and, for the improvements in examples 5 and 7, sweetness enhancement. It utilizes another sensory methodology designed to focus on the temporal profile of the sweetness attribute.

Sensory method: Six panelists were trained using a descriptive analysis methodology to precisely estimate sweetness in terms of sucrose concentration using sucrose standards acidified with 0.1% citric acid for reference. Mean values were used for data analysis. The procedure for each sample is as follows: Take a ca. 15 mL sample of the sample into the mouth swishing it around vigorously. After 3 sec, expectorate the sample, start the stopwatch and rate the sweetness aftertaste. Sweetness aftertaste intensity was rated post-expectoration at the following second intervals: 1, 4, 8, 12, 16, 20, 30, 45, 60, 75, 90, 105, 180, 210, 240, 270, 300, 330, 360, 390, 420, 450, 480, 510 and 540.

Sample preparation: All beverages were prepared using beverage standard carbon filtered water which was free from off-taste due to organic or inorganic materials. All samples were acidified with 0.1% citric acid. The sucrose reference contained 10.0% w/w sucrose purchased from Publix. The additives (from example 5) and components of emulsions (example 2, 1.0% oil) and encapsulates (pectin/gum arabic formulae) are the same as those above and were processed as above; the purity gum/pectin emulsion was the same in processing and composition as the gum arabic, 1% oil emulsion except than gum arabic was replaced with 4% purity gum and 1% pectin. It was prepared using purity gum purchased from CP Kelco/National Starch.

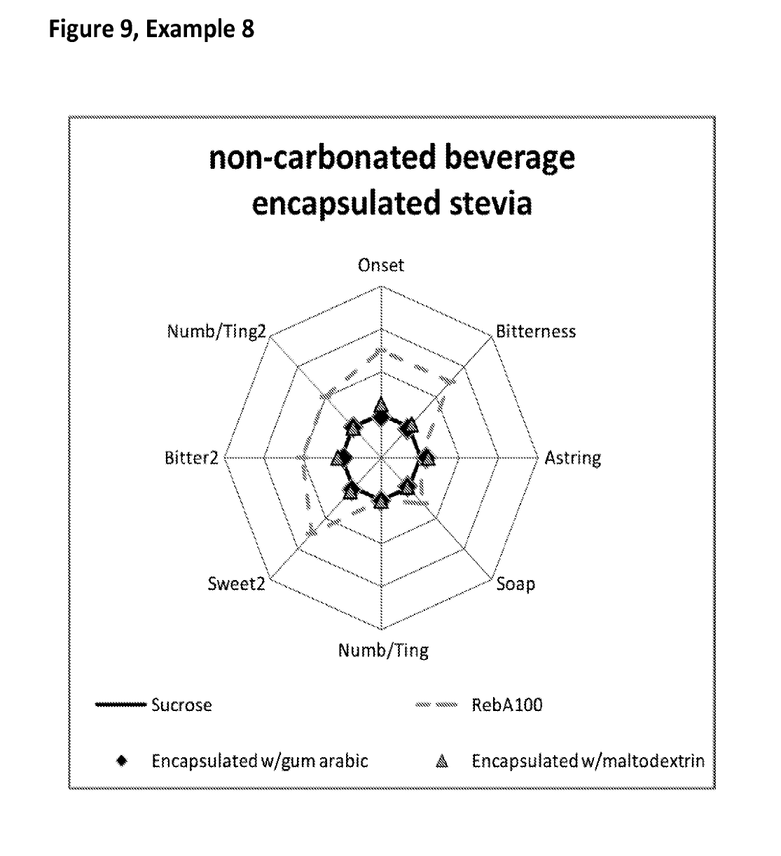

Test results: As shown in FIG. 9 time intensity graph, all products showed great reduced sweetness lingering relative to Reb A and closely approximated the profile of sucrose with the exception of the additives from example 5 which showed reduced lingering relative to sucrose. (Note: the lingering curves are longer for the emulsions and encapsulate but this is due to the increased perceived sweetness intensity.) Additives showed a directional sweetness enhancement while both emulsion and encapsulate forms demonstrate significantly enhanced sweetness intensity. Emulsion sweetness enhancement was 10-20% while the encapsulated enhanced more significantly, approximately 35%.

### Example 9

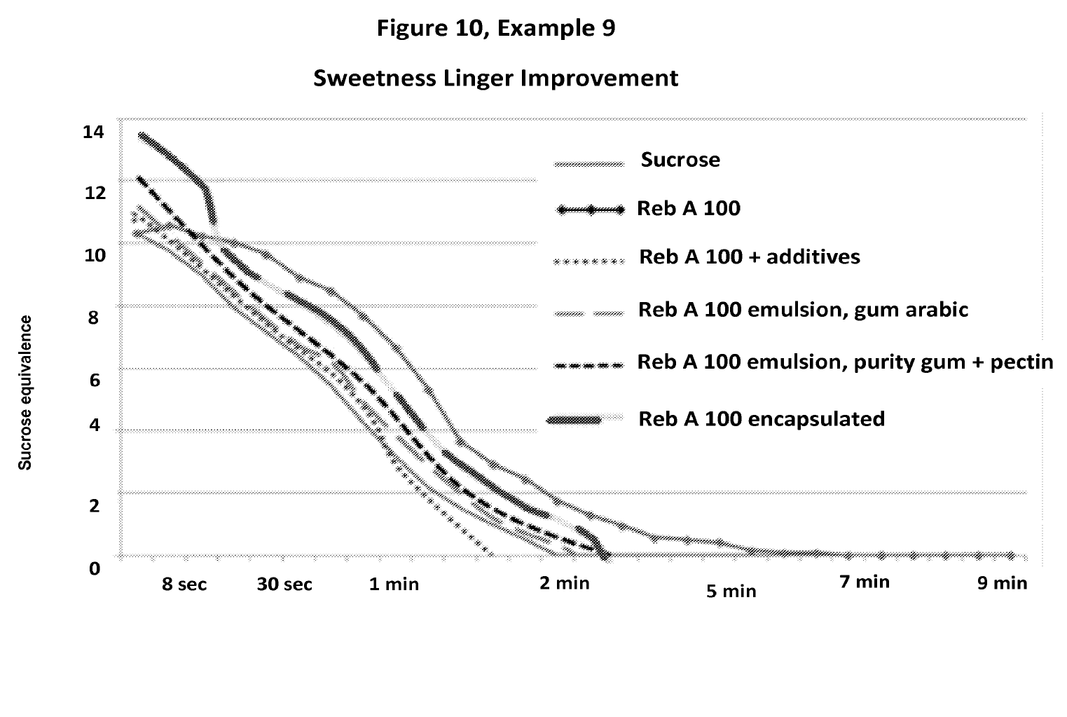

The purpose of this example is to illustrate that the sweetness improvement shown in example 2 is not due to any significant contribution of osmolality (See FIG. 10). The osmolality of each of the improvement formulations was calculated and the results are shown below.

| | | | milli |
|---|---|---|---|
| Component | mg/L | g/mole | Osmoles/L |
| betaine/trimethylglycine | 75.00 | 117.146 | 0.640 |
| glycine | 6000.00 | 75.070 | 79.925 |
| epsilon polylysine (1) | 12.50 | 4700.000 | 0.003 |
| gum arabic (2) | 5000.00 | 286000.000 | 0.017 |

Optimal Osmolality to Suppress Sweetness Linger: 500
Osmolality of Mixture: 80
Note 1:
http://www.accessdata.fda.gov/scripts/fcn/gras_notices/
Note 2:
average molecular weight of gum arabic was used per: http://www.ncbi.nlm.nih.gov/pmc/articles/PMC2157261/

In addition, the purpose of this example is to illustrate that the sweetness improvement shown in example 5 is not due to any significant contribution of osmolality. The osmolality of each of the improvement formulations was calculated and the results are shown below.

| | | | milli |
|---|---|---|---|
| Component | mg/L | g/mole | Osmoles/L |
| betaine/trimethylglycine | 75.00 | 117.146 | 0.640 |
| glycine | 1000.00 | 75.070 | 13.321 |
| choline bitartrate | 200.00 | 104.170 | 1.920 |

Optimal Osmolarity to Suppress Sweetness Linger: 500
Osmolality of Mixture: 16
Note 1:
http://www.accessdata.fda.gov/scripts/fcn/gras_notices/
Note 2:
average molecular weight of gum arabic was used per: http://www.ncbi.nlm.nih.gov/pmc/articles/PMC2157261/

Furthermore, the purpose of this example is to illustrate, in non-carbonated soft drinks, the reduction in adherence of REBA100 to the tongue and oral cavity. Reduction in adherence is understood through reduced lingering behavior of attributes, particularly numbing/tingling, and reduced initial numbing/tingling effect. It furthermore shows that a stabilized nanoemulsion comprised of rebaudiana A and olive oil can completely eradicate the negative lingering taste characteristics of aqueous solutions.

Sample preparation: The sourcing of all ingredients was as per those described above. A nano-emulsion was prepared as follows: to a 10% solution of REBA100 with 1% citric acid was added olive oil to achieve a concentration of 0.1% and mixed vigorously with a vortex mixer. It was sonicated at 50° C. for 60 minutes, then added to a solution of 0.1% citric acid in water to dilute the REBA100 to a level of 500 mg/L.

Taste Procedure: The samples were evaluated using the sensory methodology described above by two trained expert panelists. No more than 5 were evaluated in a single session to limit sensory fatigue. The only reference solution was of sucrose.

Test results: All samples containing the nano-emulsion showed 0.5 or lower scores on all lingering attributes. The sucrose reference was validated as 0 in all lingering attributes.

The variability in the results disclosed in the examples above underscore the need for multiple approaches to sweetness improvement in the context of the wide array of edible compositions that can exist in the market today. Each edible composition brings with it a unique matrix of its inherent off-tastes, “sweetness improvers” and shelf-life needs.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. In an embodiment, the term “about” can include traditional rounding according to the measuring technique and the numerical value. In addition, the phrase “about ‘x’ to ‘y’” includes “about ‘x’ to about ‘y’”.

While only a few embodiments of the present disclosure have been shown and described herein, it will become apparent to those skilled in the art that various modifications and changes can be made in the present disclosure without departing from the spirit and scope of the present disclosure. All such modification and changes coming within the scope of the appended claims are intended to be carried out thereby.

We claim at least the following:

1. A method of reducing oral cavity and tongue coating adherence and tongue numbing effects of a sweetener composition, comprising: providing to a person a sweetener composition that includes a high potency sweetener, wherein the high potency sweetener is included in an emulsified mixture.

2. The method of claim 1, wherein the high potency sweetener is selected from the group consisting of: mogroside IV, mogroside V, Luo Han Guo sweetener, siamenoside, monatin and its salts (monatin SS, RR, RS, SR), curculin, glycyrrhizic acid and its salts, thaumatin, monellin, mabinlin, brazzein, hernandulcin, phyllodulcin, glycyphyllin, phloridzin, trilobatin, baiyunoside, osladin, polypodoside A, pterocaryoside A, pterocaryoside B, mukurozioside, phlomisoside I, periandrin I, abrusoside cyclocarioside I, and modification or derivatives thereof.

3. A method of imparting a more sugar-like temporal and flavor profile to a high potency sweetener, comprising: providing to a person a sweetener composition that includes a high potency sweetener, wherein the high potency sweetener is included in an emulsified mixture.

4. The method of claim 3, wherein the high potency sweetener is selected from the group consisting of: mogroside IV, mogroside V, Luo Han Guo sweetener, siamenoside, monatin and its salts (monatin SS, RR, RS, SR), curculin, glycyrrhizic acid and its salts, thaumatin, monellin, mabinlin, brazzein, hernandulcin, phyllodulcin, glycyphyllin, phloridzin, trilobatin, baiyunoside, osladin, polypodoside A, pterocaryoside A, pterocaryoside B, mukurozioside, phlomisoside I, periandrin I, abrusoside A, cyclocarioside I, and modification or derivatives thereof.

5. A method of imparting a more sugar-like temporal and flavor profile to a high potency sweetener, comprising: providing to a person a sweetener composition that includes an encapsulated high potency sweetener.

6. The method of claim 5, wherein the high potency sweetener is selected from the group consisting of: mogroside IV, mogroside V, Luo Han Guo sweetener, siamenoside, monatin and its salts (monatin SS, RR, RS, SR), curculin, glycyrrhizic acid and its salts, thaumatin, monellin, mabinlin, brazzein, hernandulcin, phyllodulcin, glycyphyllin, phloridzin, trilobatin, baiyunoside, osladin, polypodoside A, pterocaryoside A, pterocaryoside B, mukurozioside, phlomisoside I, periandrin I, abrusoside A, cyclocarioside I, and modification or derivatives thereof.
